(19) United States
(12) Patent Application Publication
(10) Pub. No.: US 2011/0069109 A1
(43) Pub. Date: Mar. 24, 2011

(54) IMAGE FORMING METHOD

(75) Inventor: Kaoru TOJO, Kanagawa (JP)

(73) Assignee: FUJIFILM CORPORATION, Tokyo (JP)

(21) Appl. No.: 12/868,757

(22) Filed: Aug. 26, 2010

(30) Foreign Application Priority Data
Sep. 18, 2009 (JP) 2009-218015

(51) Int. Cl. B41J 2/015

(52) U.S. Cl. 347/21

(57) ABSTRACT

The present invention provides an image forming method at least including: applying, by an inkjet method, an ink composition containing at least one pigment as a coloring material, at least one kind of resin particles, at least one fluorine-based surfactant and water, on a recording medium which has a single pigment layer or multiple pigment layers on or above at least one surface of a support containing a cellulose pulp as a main component, and has an amount of transfer of purified water to a medium, when measured with a dynamic scanning absorptometer, of from 1 ml/m² to 15 ml/m² for a contact time of 100 ms, and of from 2 ml/m² to 20 ml/m² for a contact time of 400 ms; and applying a treatment liquid containing at least one aggregating agent that aggregates components in the ink composition.

### CROSS-REFERENCE TO RELATED APPLICATION

This application is based on and claims priority under 35 USC 119 from Japanese Patent Application No. 2009-218015 filed on Sep. 18, 2009, the disclosure of which is incorporated herein by reference in its entirety.

### BACKGROUND OF THE INVENTION

1. Field of the Invention

The present invention relates to an image forming method.

2. Description of the Related Art

An inkjet recording method is a method of performing recording by ejecting ink in the form of droplets toward a recording medium, and fixing the ink to the recording medium. This method has hitherto been used mainly in the fields such as office printers and domestic printers, but in recent years, the method is being applied to the field of commercial printing.

Since the inkjet recording method is based on a technology of ejecting ink from fine nozzles at a high speed, a low-concentration and low-viscosity ink is used, and the amount of ink is also larger. Therefore, papers exclusive for inkjet use having an ink absorption layer have been developed; however, these exclusive papers are highly expensive, and thus are not suitable for commercial printing in terms of cost.

One of those recording media that are widely used in commercial printing is a coated paper having the paper surface coated with a pigment for the purpose of mainly improving the non-uniformity of paper surface. This coated paper is not designed to absorb a large amount of ink in a short time, and thus when the coated paper is used as an inkjet recording medium, bleeding of ink occurs widely, and it is difficult to obtain high-definition images. Furthermore, since the pigments used in the coating are cheap products such as calcium carbonate and kaolin, and high concealability is exhibited in a case in which bleeding of ink occurs, development of the print density is weakened. In order to apply the inkjet recording method to the field of commercial printing, a response capability to such recording media that are widely used in commercial printing as described above is required.

Furthermore, in the field of commercial printing, there is a demand for speeding up of inkjet recording, and for example, it is desirable that the time required for the treatments after recording, such as drying and fixing, be shorter. However, if the time for these treatments is shortened, it may not catch up with the drying or penetration into a recording medium of water or an organic solvent that is contained in the ink, and while an image is still soft, another recording medium may be superposed on that image, so that the blocking phenomenon in which the image area is transferred to the rear side of a recording medium, is easy to occur. Furthermore, in a recording system where a member such as a roller is brought into contact with the image subsequently to the drying treatment, as in the case of a recording system that fixes the image by heating and pressing, if a sufficient drying time is not secured after recording, the offset phenomenon in which the image is transferred to the roller and causes contamination of the roller or image defects, may occur.

In regard to these problems, there have been disclosed an ink for recording defined by the content of solid components in the ink, the content ratio of the liquid components/solid components and the viscosity of the ink, and an inkjet recording method using this ink (see, for example, Japanese Unexamined Patent Application Publication (JP-A) No. 2008-101192). There is also disclosed an inkjet recording method characterized by performing printing at a predetermined amount of ink adherence, on a coated paper defined by the amount of transfer of purified water to a medium as measured by a dynamic scanning absorptometer, tack-drying the image, and then fixing by directly bringing the media and a heat source into contact (see, for example, JP-A-2008-100511).

In the ink described in JP-A-2008-101192 mentioned above, resin particles is incorporated in order to improve beading (image bleeding) and drying property. However, according to the descriptions in the Examples, it is found that the surface tension of the ink is low (25.1 mN/m or less). As a result, particularly in the case of performing printing on printing paper such as coated paper, lightweight coated paper or lightly coated paper, ink droplets are prone to spread, and it is difficult to form high quality images with high resolution.

The ink used in the inkjet recording method described in JP-A-2008-100511 also has low surface tension (25.0 mN/m). As a result, ink droplets are prone to spread, so that it is difficult to form high quality images with high resolution.

### SUMMARY OF THE INVENTION

The present invention was made under such circumstances so as to address the problem shown below.

The present invention provides an image forming method including at least an ink applying step of applying, by an inkjet method, an ink composition containing at least one pigment as a coloring material, at least one kind of resin particles, at least one fluorine-based surfactant and water, onto a recording medium having a single pigment layer or multiple pigment layers provided on or above at least one surface of a support containing a cellulose pulp as a main component, and showing an amount of transfer of purified water to a medium, when measured with a dynamic scanning absorptometer, of from 1 ml/m² to 15 ml/m² for a contact time of 100 ms, and of from 2 ml/m² to 20 ml/m² for a contact time of 400 ms; and a treatment liquid applying step of applying a treatment liquid containing at least one aggregating agent that aggregates components in the ink composition.

### BRIEF DESCRIPTION OF THE DRAWINGS

FIG. 1 is a schematic diagram showing a construction example of the inkjet recording apparatus used in the image forming method of the invention.

### DETAILED DESCRIPTION OF THE INVENTION

The image forming method of the invention includes at least an ink applying step of applying, by an inkjet method, an ink composition containing at least one pigment as a coloring material, at least one kind of resin particles, at least one fluorine-based surfactant and water, onto a recording medium having a single pigment layer or multiple pigment layers provided on or above at least one surface of a support containing a cellulose pulp as a main component, and showing an amount of transfer of purified water to a medium, when measured with a dynamic scanning absorptometer, of from 1 ml/m² to 15 ml/m² for a contact time of 100 ms, and of from 2 ml/m² to 20 ml/m² for a contact time of 400 ms; and a treatment liquid applying step of applying a treating liquid containing at least one aggregating agent that aggregates the components in the ink composition.

In the image forming method of the invention, recording of an image is performed using an ink composition and a treatment liquid on a recording medium. According to the invention, spread of the ink on paper is suppressed by using a treatment liquid containing an aggregating agent that aggregates components of the ink composition. Furthermore, uniform solid images may be formed by incorporating a fluorine-based surfactant into the ink composition. That is, in the image forming method of the invention, high resolution and uniformity of solid images in combination may be achieved by using an ink composition containing a fluorine-based surfactant and a treatment liquid.

Ink Applying Step

The image forming method of the invention includes an ink applying step of ejecting the ink composition according to the invention onto the recording medium according to the invention by an inkjet method, and thereby applying the ink composition onto the recording medium.

The image forming method of the invention is an image forming method including image recording steps of recording an image by the ink applying step and the treatment liquid applying step that will be described below.

In the image recording process according to the inkjet method, the ink composition is ejected onto the recording medium by providing energy, and thereby a colored image is formed. As an inkjet method preferable for the invention, the method described in paragraphs [0093] to [0105] of JP-A-2003-306623 may be applied.

The inkjet method is not particularly limited, and it is possible to use any known system, for example, a charge control system that ejects ink by utilizing an electrostatic attraction force; a drop on demand system that utilizes vibration pressure of a piezoelectric element (pressure pulse system); an acoustic ink-jet system that converts electric signals into acoustic beams, irradiates ink with the beams, and ejects the ink by utilizing a radiation pressure; and a thermal ink-jet system that heats ink to form bubbles and utilizes the pressure resulting therefrom. As the ink-jet method, particularly an ink-jet method described in JP-A No. 54-59936, in which an ink that has been affected by heat energy undergoes an abrupt volume change, and the ink is ejected from a nozzle by the acting force resulting from this change of state, can be effectively utilized.

Furthermore, the inkjet method described above includes the usage of a system that injects a large number of small-volume droplets of a low-concentration ink called photo-ink; a system that improves the image quality by using plural kinds of inks having a substantially identical hue but different concentrations; and a system that makes use of a colorless transparent ink.

In the image recording steps, an image may be recorded by, for example, changing the conveyance speed of the recording medium. The conveyance speed is not particularly limited as long as the speed is maintained in the range that does not cause impairment of the image quality, and the conveyance speed is preferably 100 to 3000 mm/s, more preferably 150 to 2700 mm/s, and even more preferably 250 to 2500 mm/s.

Recording Medium

The recording medium according to the invention has a single pigment layer or multiple pigment layers on at least one surface of a support containing a cellulose pulp as a main component, and has an amount of transfer of purified water to the recording medium, when measured with a dynamic scanning absorptometer, of from 1 ml/m² to 15 ml/m² for a contact time of 100 ms, and of from 2 ml/m² to 20 ml/m² for a contact time of 400 ms.

Support

As the support according to the invention containing a cellulose pulp as a main component, use is made of a support obtained by subjecting a raw material produced by mixing a chemical pulp, a mechanical pulp, a pulp recovered from used paper and the like at an arbitrary ratio and adding thereto an internally added sizing agent, a yield enhancing agent, a paper strength increasing agent and the like as necessary, to papermaking using a twin wire former of Fourdrinier type or gap type, a hybrid former having the latter half section of the Fourdrinier unit constructed from twin wires, or the like.

Here, the term “main component” refers to a component that is contained at a proportion of 50% by mass or more based on the mass of the support.

The pulp used in the support may contain a virgin chemical pulp (CP), for example, a virgin chemical pulp produced by chemically treating wood and other fibrous raw materials, such as bleached hardwood kraft pulp, bleached softwood kraft pulp, unbleached hardwood kraft pulp, unbleached softwood kraft pulp, bleached hardwood sulfite pulp, bleached softwood sulfite pulp, unbleached hardwood sulfite pulp or unbleached softwood sulfite pulp; and a virgin mechanical pulp (MP), for example, a virgin mechanical pulp produced by mainly mechanically treating wood and other fibrous raw materials, such as ground pulp, chemiground pulp, chemimechanical pulp or semichemical pulp. A recycled pulp may also be used, and examples of the raw material for the recycled pulp include white superior paper, white ruled paper, cream white paper, cardboards, extra white paper, medium white paper, simili paper, fair white paper, Kent paper, white art paper, special top cuttings, separate top cuttings, newspaper, and magazine paper, as defined in the standard specifications of used paper quality published by the Paper Recycling Promotion Center. Specific examples include used paper of paper or cardboard, such as printer papers such as an uncoated computer paper, which is a paper for data processing, heat-sensitive paper and pressure-sensitive paper; OA used papers such as PPC paper; coated papers such as art paper, coated paper, lightly coated paper, and matte paper; uncoated paper such as wood free paper, color wood free paper, notebook paper, letter writing paper, wrapping paper, fancy paper, medium quality paper, newspaper, groundwood paper, super wrapping paper, simili paper, pure white roll paper and milk carton paper; and chemical pulp paper, and high yield pulp-containing paper. These may be used singly, or may be used in combination of two or more kinds.

An effective loading material that may be used in the support is calcium carbonate, but inorganic loading materials such as silicates, including kaolin, calcined clay, pyrophillite, sericite and talc, or organic pigments such as satin white, barium sulfate, calcium sulfate, zinc sulfide, plastic pigments and urea resins, may also be used together.

The internally added sizing agent used in the support is not particularly limited, and any sizing agent may be appropriately selected from known internally added sizing agents for use. Preferred examples of the internally added sizing agent include rosin emulsion-based sizing agents. Examples of the internally added sizing agents that are used during performing papermaking for the support, include the neutral rosin-based sizing agents used in neutral papermaking, alkenyl succinic anhydride (ASA), alkyl ketene dimers (AKD), and petroleum resin-based sizing agents. Among these, the neutral rosin sizing agents and alkenyl succinic anhydride are particularly suitable. The alkyl ketene dimers may be added in small amounts since their sizing effect is high; however, since the coefficient of friction at the surface of the recording medium decreases, and the surface becomes slippery, it may not be preferable to use the alkyl ketene dimers from the viewpoint of conveyability at the time of inkjet recording.

The amount of use of the internally added sizing agent is 0.1 to 0.7 parts by weight relative to 100 parts by weight of bone-dry pulp, but the amount is not intended to be limited to this range.

As the internally added loading material used in the support, for example, those pigments conventionally known as white pigments, are used. Examples of the white pigment include white inorganic pigments such as light calcium carbonate, heavy calcium carbonate, kaolin, clay, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic silica, aluminum hydroxide, alumina, lithopone, zeolite, magnesium carbonate, and magnesium hydroxide; and organic pigments such as styrene-based plastic pigments, acrylic plastic pigments, polyethylene, microcapsules, urea resins, and melamine resins. These may be used singly, or may be used in combination of two or more kinds.

Pigment Layer

The recording medium according to the invention has a single pigment layer or multiple pigment layers provided on or above at least one surface of the support.

The pigment used in the pigment layer is not particularly limited in type, and conventionally known organic pigments and inorganic pigments may be used. These pigments may be used singly or as mixtures of two or more kinds.

Examples of the pigment include white inorganic pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, quasi-boehmite, aluminum hydroxide, aluminum oxide (alumina), lithopone, zeolite, hydrated halloysite, magnesium carbonate, and magnesium hydroxide; and organic pigments such as styrene-based plastic pigments, acrylic plastic pigments, polyethylene, microcapsules, urea resins, and melamine resins. From the viewpoint of increasing the print density by maintaining the transparency of the recording medium, a white pigment is preferred.

The pigment layer may further contain additives such as an aqueous binder, an antioxidant, a surfactant, a defoaming agent, a foam suppressor, a pH adjusting agent, a hardening agent, a colorant, a fluorescent brightening agent, a preservative, and an anti-hydration agent.

Examples of the aqueous binder include a water-soluble polymer such as a styrene/maleate copolymer, a styrene/acrylate copolymer, polyvinyl alcohol, silanol-modified polyvinyl alcohol, starch, cationized starch, casein, gelatin, carboxymethyl cellulose, hydroxyethyl cellulose, and polyvinylpyrrolidone; and a water-dispersible polymer such as styrene-butadiene latex and an acrylic emulsion.

The method for forming a pigment layer on or above the support may be appropriately selected according to the purpose without any particular limitation. For example, a pigment layer may be formed by coating, on or above a base paper, a dispersion liquid prepared by dispersing a pigment in water, and drying the dispersion liquid.

According to the invention, the amount of the pigment in the pigment layer is preferably in the range of from 0.1 g/m² to 20 g/m², and more preferably in the range of from 0.5 g/m² to 10 g/m². If the amount of the pigment is adjusted to the range, the anti-blocking properties and brittleness resistance are improved.

Furthermore, the pigment contained in the pigment layer is preferably contained in an amount of 10% by mass or more, more preferably 14% by mass or more, and even more preferably 18% by mass or more, relative to the total solids content of the pigment layer.

Physicality of Recording Medium

The recording medium according to the invention is characterized in that the amount of transfer of purified water to the recording medium, when measured with a dynamic scanning absorptometer, is from 1 ml/m² to 15 ml/m² for a contact time of 100 ms, and is from 2 ml/m² to 20 ml/m² for a contact time of 400 ms.

In the image forming method of the invention, a recorded image showing high resolution and excellent rubbing resistance may be obtained by using the recording medium showing a relatively small amount of ink absorption, which is in the range of the amount of transfer mentioned above. In other words, according to the image forming method of the invention, a recorded image showing high resolution and excellent rubbing resistance may be obtained by an inkjet method, even though a recording medium (for example, paper exclusive for inkjet use) which is capable of absorbing a large amount of ink and exhibits an amount of transfer exceeding the range of amount of transfer described above is not used.

In connection with the amount of transfer, the amount of transfer being 1 ml/m² or more for a contact time of 100 ms and being 2 ml/m² or more for a contact time of 400 ms, means that the recording medium has a pigment layer capable of absorbing ink.

Here, the dynamic scanning absorptometer (DSA; Kuga, Shigenori, Journal of Japan Technical Association of the Pulp and Paper Industry, vol. 48, May 1994, pp. 88-92) is an apparatus capable of accurately measuring the amount of liquid absorption in a very short time. The dynamic scanning absorptometer is an apparatus which directly reads the rate of liquid absorption on the basis of the movement of the meniscus in a capillary, in which apparatus measurement is automated according to a method of using a disk-shaped sample, scanning the liquid absorption head in a helical path on the sample, automatically changing the scanning rate according to a preliminarily established pattern, and making measurements for the number of sites required in one sheet of sample. The head for liquid supply to the paper sample is connected to the capillary via a TEFLON® tube, and the position of the meniscus in the capillary is automatically read with an optical sensor. Specifically, the amount of transfer of purified water or ink was measured using a dynamic scanning absorptometer (trade name: K350 Series Model D, manufactured by Kyowa Seiko Co., Ltd.). The amounts of transfer for a contact time of 100 ms and a contact time of 400 ms may be determined by interpolation of measurement values of the amount of transfer at the contact times close to the respective contact times. The measurement was carried out at 23° C. and 50% RH.

In regard to the recording medium according to the invention, the amount of transfer of purified water to the recording medium in a contact time of 100 ms as measured with a dynamic scanning absorptometer is preferably 1 ml/m² to 15 ml/m², more preferably 1 ml/m² to 10 ml/m², and even more preferably 1 ml/m² to 8 ml/m². If the amount of transfer of purified water in a contact time of 100 ms is too small, beading is prone to occur. If the amount of transfer is too large, the ink dot diameter after recording may become excessively smaller than the desired dot diameter.

Here, the term beading refers to a phenomenon in which upon inkjet recording, between the time point when a first ink droplet is dotted on a recording medium and the time point when a second ink droplet is dotted on the recording medium, the first ink droplet is not completely absorbed into the recording medium but remains in the liquid state at the surface of the recording medium, and is mixed with the second ink droplets dotted on the recording medium later, thereby a colorant contained in the ink partially aggregates and thus causes density unevenness.

In the recording medium according to the invention, the amount of transfer of purified water to the recording medium in a contact time of 400 ms, when measured with a dynamic scanning absorptometer, is 2 ml/m² to 20 ml/m², preferably 2 ml/m² to 15 ml/m², and more preferably 2 ml/m² to 10 ml/m². If the amount of transfer in a contact time of 400 ms is too small, dryability of the recording medium is insufficient, and thus spur marks are prone to occur. If the amount of transfer is too large, bleeding is likely to occur, and the gloss at the image areas after drying may be decreased.

The pigment layer of the recording medium according to the invention is constituted to include a pigment and a resin binder as main components. The constitution is adjustable such that the amount of resin incorporation may be increased so as to decrease the amount of transfer, and the amount of pigment incorporation may be increased so as to increase the amount of transfer. The amount of transfer may also be increased by increasing the specific surface area of the pigment particles that constitute the pigment layer, for example, by decreasing the particle size or using a type of pigment having a large specific surface area.

As the recording medium according to the invention, use may be made of, for example, a so-called coated paper, which is used in general offset printing or the like. The coated paper is a paper provided with a coating layer by applying a coating material on the surface of a wood free paper or neutral paper, which is formed mainly from cellulose and generally is not surface-treated. Generally, in the process of image formation based on a conventional aqueous inkjet system using a coated paper as a recording medium, problems in terms of quality, such as image bleeding and rubbing resistance easily occur. In contrast, in the image forming method of the invention, image bleeding is suppressed, so that the density is uniform, and the occurrence of density unevenness is prevented. Thus, images showing high resolution and satisfactory rubbing resistance may be recorded.

According to the image forming method of the invention, a coated paper, a lightweight coated paper or a lightly coated paper may be suitably used, and high-definition images may be effectively formed on these recording media.

In regard to the coated paper, general commercial products are available and these products may be used. For example, a coated paper for general printing may be used, and specific examples include, in the class of A2 gloss paper, “OK TOPCOAT+” (trade name, manufactured by Oji Paper Co., Ltd.), “AURORA COAT” (trade name, manufactured by Nippon Paper Group), “PEARL COAT” (trade name, manufactured by Mitsubishi Paper Mills, Ltd.), “S-UTRILLO COAT” (trade name, manufactured by Daio Paper Corp.), “MU COAT NEOS” (trade name, manufactured by Hokuetsu Kishu Paper Co., Ltd.), and “RAICHO COAT” (trade name, manufactured by Chuetsu Pulp & Paper Co., Ltd.); in the class of A2 matte paper, “NEWAGE” (trade name, manufactured by Oji Paper Co., Ltd.), “OK TOPCOAT MAT” (trade name, manufactured by Oji Paper Co., Ltd.), “U-LITE” (trade name, manufactured by Nippon Paper Group), “NEW V MAT” (trade name, manufactured by Mitsubishi Paper Mills, Ltd.), and “RAICHO MAT COAT N” (trade name, manufactured by Chuetsu Pulp & Paper Co., Ltd.); in the class of A1 gloss art paper, “OK KINFUJI+” (trade name, manufactured by Oji Paper Co., Ltd.), “TOKUBISHI ART” (trade name, manufactured by Mitsubishi Paper Mills, Ltd.), and “RAICHO SPECIAL ART” (trade name, manufactured by Chuetsu Pulp & Paper Co., Ltd.); in the class of A1 dull art paper, “SATIN KINFUJI+” (trade name, manufactured by Oji Paper Co., Ltd.), “SUPER MAT ART” (trade name, manufactured by Mitsubishi Paper Mills, Ltd.), and “RAICHO DULL ART” (trade name, manufactured by Chuetsu Pulp & Paper Co., Ltd.); in the class of A0 art paper, “SA KINFUJI+” (trade name, manufactured by Oji Paper Co., Ltd.), “HIGH-GRADE ART” (trade name, manufactured by Mitsubishi Paper Mills, Ltd.), “RAICHO SUPER ART N” (trade name, manufactured by Chuetsu Pulp & Paper Co., Ltd.), “ULTRA SATIN KINFUJI+” (trade name, manufactured by Oji Paper Co., Ltd.), and “DIA PREMIER DULL ART” (trade name, manufactured by Mitsubishi Paper Mills, Ltd.).

Next, the ink composition used in the image forming method of the invention will be explained in detail.

<Ink Composition>

The ink composition according to the invention contains at least one pigment as a coloring material, at least one kind of resin particles, at least one fluorine-based surfactant, and water.

The ink composition is used as an ink for inkjet recording, and may be used in the recording of color images. For example, in the case of forming full color images, the ink composition is preferably used as a magenta color ink, a cyan color ink and a yellow color ink, and may also be used as a black color ink for adjusting the color tone. The ink composition may also be used as a red ink, a green ink, a blue ink, a white ink, or a so-called special color ink as used in the printing field, in addition to the yellow, magenta or cyan color ink.

Pigment

The ink composition according to the invention contains at least one pigment as a coloring material. The pigment is not particularly limited, and may be appropriately selected according to the purpose. The pigment may be, for example, any of an inorganic pigment and an organic pigment.

Examples of the inorganic pigment include titanium oxide, iron oxide, calcium carbonate, barium sulfate, aluminum hydroxide, Barium Yellow, Cadmium Red, Chrome Yellow, carbon black, Prussian Blue, and metal powders. Among these, carbon black and the like are preferred. Examples of the carbon black include products produced according to known methods such as a contact method, a furnace method and a thermal method.

Examples of the organic pigment include an azo pigment, a polycyclic pigment, a dye chelate, a nitro pigment, a nitroso pigment, and an aniline black. Among these, an azo pigment, a polycyclic pigment, and the like are more preferred. Examples of the azo pigment include an azo lake, an insoluble azo pigment, a condensed azo pigment and a chelate azo pigment. Examples of the polycyclic pigment include a phthalocyanine pigment, a perylene pigment, a perinone pigment, an anthraquinone pigment, a quinacridone pigment, a dioxazine pigment, an indigo pigment, a thioindigo pigment, an isoindolinone pigment, a quinoflarone pigment, an azomethine-based pigment, and a Rhodamine B lake pigment. Examples of the dye chelate include a basic dye chelate and an acidic dye chelate.

The color of the pigment is not particularly limited, and may be appropriately selected according to the purpose. For example, pigments for black color ink, and pigments for color inks may be used. These may be used singly, or may be used in combination of two or more kinds.

As the pigment, a self-dispersing pigment which has at least one hydrophilic group bound to the surface of the pigment directly or via another atomic group, and may be stably dispersed without using a dispersant, is suitably used. As a result, it is not necessary to use a dispersant for dispersing the pigment, unlikely in the case of conventional inks. It is preferable that the self-dispersing pigment is ionic, and an anionically charged pigment or a cationically charged pigment is suitable.

The volume average particle size of the self-dispersing pigment in the ink is preferably from 0.01 μm to 1.16 μm.

Examples of the anionic hydrophilic group include —COOM, —SO₃M, —PO₃HM, —PO₃M₂, —SO₂NH₂ and —SO₂NHCOR (wherein M represents a hydrogen atom, an alkali metal, ammonium or an organic ammonium; and R represents an alkyl group having 1 to 12 carbon atoms, a phenyl group which may be substituted, or a naphthyl group which may be substituted). Among these, it is preferable to use color pigments having —COOM and/or —SO₃M bound to the surface of the pigments.

When “M” in the hydrophilic group represents an alkali metal, examples of the alkali metal include lithium, sodium and potassium. When “M” in the hydrophilic group is an organic ammonium, examples of the organic ammonium include mono- to tri-methylammonium, mono- to tri-ethylammonium, and mono- to tri-methanolammonium. In regard to the method of obtaining the anionically charged color pigment, methods of introducing the group —COONa to the surface of the color pigment include, for example, a method of subjecting the color pigment to an oxidation treatment using sodium hypochlorite, a method of subjecting the color pigment to sulfonation, and a method of reacting the color pigment with a diazonium salt.

The cationic hydrophilic group is preferably, for example, a quaternary ammonium group, and more preferred examples include the quaternary ammonium groups listed below. A product having any of these groups bound to the pigment surface is suitable as a coloring material.

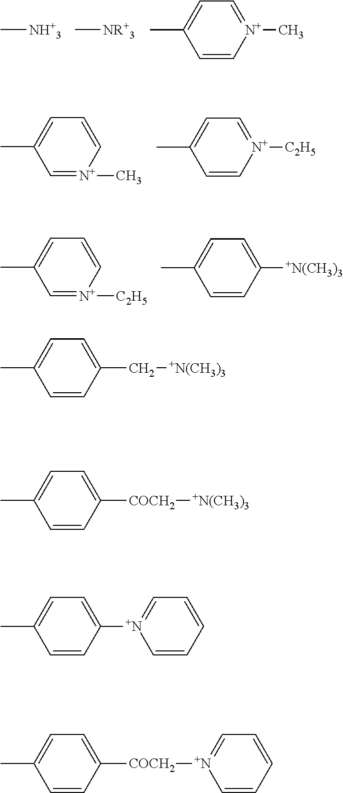

As a method for producing a cationic self-dispersing carbon black having at least one of the hydrophilic groups bound thereto, for example, a method of treating carbon black with 3-amino-N-ethylpyridium bromide may be mentioned as a method of binding an N-ethylpyridyl group represented by the following structural formula. However, the invention is not intended to be limited thereto.

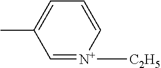

According to the invention, the hydrophilic group may be bound to the surface of carbon black via another atomic group. Examples of the other atomic group include an alkyl group having 1 to 12 carbon atoms, a phenyl group which may be substituted, and a naphthyl group which may be substituted. When the hydrophilic group mentioned above is bound to the surface of carbon black via another atomic group, specific examples of the another atomic group include —C₂H₄COOM (wherein M represents an alkali metal or a quaternary ammonium), —PhSO₃M (wherein Ph represents a phenyl group; and M represents an alkali metal or a quaternary ammonium), and —C₅H₁₀NH₃⁺.

According to the invention, a pigment-dispersion liquid formed using a pigment dispersant may be used.

Examples of the pigment dispersant include, as naturally-occurring hydrophilic polymer compounds, plant-derived polymers such as gum arabic, tragacanth gum, guar gum, karaya gum, locust bean gum, arabinogalactone, pectin and quince seed starch; seaweed-derived polymers such as alginic acid, carrageenan and agar; animal-derived polymers such as gelatin, casein albumin, collagen and shellac; and microbial-derived polymers such as xanthene gum and dextran. Examples of semi-synthetic hydrophilic polymers include cellulosic polymers such as methylcellulose, ethylcellulose, hydroxyethyl cellulose, hydroxypropyl cellulose and carboxymethyl cellulose; starch-based polymers such as sodium starch glycolate and sodium starch phosphate ester; seaweed-based polymers such as sodium alginate, and alginic acid propylene glycol ester. Examples of fully synthetic hydrophilic polymers include vinyl-based polymers such as polyvinyl alcohol, polyvinylpyrrolidone, and polyvinyl methyl ether; acrylic resins such as non-crosslinked polyacrylamide, polyacrylic acid or an alkali metal salt thereof, and a water-soluble styrene-acrylic resin; a water-soluble styrene-maleic acid resin, a water-soluble vinylnaphthalene acrylic resin, a water-soluble vinylnaphthalene maleic acid resin, polyvinylpyrrolidone, an alkali metal salt of β-naphthalenesulfonic acid-formalin condensate, and a polymer compound having a salt of a cationic functional group such as a quaternary ammonium or an amino group in a side chain. Among these, a polymer introduced with a carboxyl group, such as a homopolymer of acrylic acid, methacrylic acid or styrene-acrylic acid, or a copolymer of such acrylic monomer with a monomer having a different hydrophilic group, is particularly preferable as a polymeric dispersant.

The weight average molecular weight of the copolymer is preferably 3,000 to 50,000, more preferably 5,000 to 30,000, and even more preferably 7,000 to 15,000. The mixing ratio by mass of the pigment and the dispersant is preferably in the range of from 1:0.06 to 1:3, and more preferably in the range of from 1:0.125 to 1:3.

Using a polymeric dispersant and a self-dispersing pigment at the same time is a preferable combination because an appropriate dot diameter may be obtained. The reason is not clearly known, but it may be speculated as follows.

When a polymeric dispersant is incorporated, penetration into the recording paper is suppressed. Further, since aggregation of the self-dispersing pigment is suppressed by incorporating a polymeric dispersant, the self-dispersing pigment may be smoothly spread in the horizontal direction. Therefore, dots are spread widely and thinly, and thus it is thought that ideal dots may be formed.

Dispersibility may also be imparted to the pigment by coating the pigment with a resin having a hydrophilic group to microencapsulate the pigment.

As the method of microencapsulating a water-insoluble pigment by coating the pigment with an organic polymer, any conventionally known methods may be used without any particular limitation. Examples of the conventionally known methods include a chemical production method, a physical production method, a physicochemical method, and a mechanical production method. Specific examples include the interface polymerization method described in paragraph [0085] of JP-A-2008-100511, an in-situ polymerization method, an in-liquid curing coating method, a coacervation (phase separation) method, an in-liquid drying method, a melting-dispersion-cooling method, an in-air suspension coating method, a spray drying method, an acid precipitation method, and an phase inversion emulsification method.

Examples of the organic polymer (resin) used as a material that constitutes the wall film material of the microcapsules, include polyamide, polyurethane, polyester, polyurea, an epoxy resin, a polycarbonate, a urea resin, a melamine resin, a phenolic resin, a polysaccharides, gelatin, gum arabic, dextran, casein, a protein, a natural rubber, carboxypolymethylene, polyvinyl alcohol, polyvinylpyrrolidone, polyvinyl acetate, polyvinyl chloride, polyvinylidene chloride, cellulose, ethylcellulose, methylcellulose, nitrocellulose, hydroxyethyl cellulose, cellulose acetate, polyethylene, polystyrene, a homopolymer or a copolymer of (meth)acrylic acid, a polymer or a copolymer of a (meth)acrylic acid ester, a (meth)acrylic acid-(meth)acrylic acid ester copolymer, a styrene-(meth)acrylic acid copolymer, a styrene-maleic acid copolymer, sodium alginate, a fatty acid, paraffin, beeswax, water wax, hardened beef tallow, carnauba wax, and albumin.

Among these, an organic polymer having an anionic group such as a carboxylic acid or a sulfonic acid group may be used. Furthermore, examples of the nonionic organic polymer include polyvinyl alcohol, polyethylene glycol monomethacrylate, polypropylene glycol monomethacrylate, methoxypolyethylene glycol monomethacrylate, or (co)polymers thereof, and a cationic ring-opening polymer of 2-oxazoline. Particularly, a complete saponification product of polyvinyl alcohol has low water-solubility, and has a property that the polymer is easily solved in hot water but is hardly solved in cold water, which is particularly preferable.

The amount of the organic polymer constituting the wall film material of the microcapsules is from 1% by mass to 20% by mass based on the water-insoluble coloring material such as an organic pigment or carbon black. When the amount of the organic polymer is adjusted to the range described above, the content of the organic polymer in the microcapsules is relatively lowered, and therefore, a decrease in the color developability of the pigment, which is caused by the organic polymer covering the pigment surface, may be suppressed. When the amount of the organic polymer is less than 1% by mass, it is more difficult to exhibit the effect of encapsulation, and on the other hand, if the amount of the organic polymer exceeds 20% by mass, the color developability of the pigment is conspicuously decreased. When other characteristics are taken into further consideration, the amount of the organic polymer is preferably in the range of from 5 to 10% by mass based on the water-insoluble coloring material.

That is, since a portion of the coloring material is substantially exposed without being coated, a decrease in the color developability may be suppressed. On the other hand, since a portion of the coloring material is substantially coated without being exposed, the effect obtainable from a coated pigment may be simultaneously manifested. Furthermore, the number average molecular weight of the organic polymer used in the invention is preferably 2000 or more, in view of the capsule production. Here, the term “substantially exposed” does not refer to the partial exposure resulting from defects such as pinholes and cracks, but means the state of being intentionally exposed.

Furthermore, when an organic pigment which is a self-dispersing pigment, or a self-dispersing carbon black is used as the coloring material, even if the content of the organic polymer in the microcapsules is relatively low, the dispersibility of the pigment is enhanced, and thus sufficient storage stability of the ink may be secured. Therefore, the use of a self-dispersing pigment or a self-dispersing carbon black is more preferable for the invention.

It is preferable to select a suitable organic polymer in accordance with the method of microencapsulation. For example, in the case of performing microencapsulation according to an interface polymerization method, polyester, polyamide, polyurethane, polyvinylpyrrolidone, an epoxy resin and the like are suitable. In the case of performing microencapsulation according to an in-situ polymerization method, a polymer or copolymer of a (meth)acrylic acid ester, a (meth)acrylic acid-(meth)acrylic acid ester copolymer, a styrene-(meth)acrylic acid copolymer, polyvinyl chloride, polyvinylidene chloride, polyamide and the like are suitable. In the case of performing microencapsulation according to an in-liquid curing method, sodium alginate, polyvinyl alcohol, gelatin, albumin, an epoxy resin and the like are suitable. In the case of performing microencapsulation according a coacervation method, gelatin, celluloses, casein and the like are suitable. Furthermore, in order to obtain a fine and uniform microencapsulated pigment, any other conventionally known encapsulation methods may be used in addition to the methods described above.

In the case of selecting a phase inversion method or an acid precipitation method as the method of microencapsulation, an anionic organic polymer is used as the organic polymer that constitutes the wall film material of the microcapsules. The phase inversion method is a method of achieving microencapsulation while allowing self-dispersion (phase inversion emulsification), by employing a compound or composite of an anionic organic polymer having self-dispersibility or solubility in water and a coloring material such as a self-dispersing organic pigment or a self-dispersing carbon black, or a mixture of a coloring material such as a self-dispersing organic pigment or a self-dispersing carbon black, a curing agent and an anionic organic polymer, as an organic solvent phase, and introducing water into the organic solvent phase or introducing the organic solvent phase into water. In regard to the phase inversion method, even if the microcapsules are produced by incorporating a vehicle for recording liquid or an additive into the organic solvent phase, there is no problem at all. Particularly, from the viewpoint that a dispersion liquid for recording liquid may be directly produced, it is more preferable to incorporate the liquid medium of the recording liquid.

On the other hand, the acid precipitation method is a method of achieving microencapsulation by neutralizing, using a basic compound, a part or all of the anionic groups of a hydrated cake obtainable according to a production method including a step of neutralizing a part or all of the anionic groups of an anionic group-containing organic polymer with a basic compound and kneading the resultant with a coloring material such as a self-dispersing organic pigment or a self-dispersing carbon black in an aqueous medium, and a step of precipitating the anionic group-containing organic polymer by making the pH neutral or acidic using an acidic compound, and thereby fixing the organic polymer to a pigment. As such, an aqueous dispersion liquid containing a microencapsulated anionic pigment, which dispersion liquid includes a large amount of finely dispersed pigment, may be produced.

Examples of the solvent that is used upon microencapsulation as described above, include alkyl alcohols such as methanol, ethanol, propanol and butanol; aromatic hydrocarbons such as benzol, toluol and xylol; esters such as methyl acetate, ethyl acetate and butyl acetate; chlorinated hydrocarbons such as chloroform and ethylene dichloride; ketones such as acetone and methyl isobutyl ketone; ethers such as tetrahydrofuran and dioxane; and cellosolves such as methylcellosolve and butylcellosolve. The microcapsules prepared by the method described above are separated once from these solvents by centrifugation, filtration or the like, these microcapsules are subjected, together with water and a necessary solvent, to stirring and redispersion, and thereby the desired recording liquid that may be used in the invention is obtained. The average particle size of the encapsulated pigment obtainable by the method as described above is preferably 50 nm to 180 nm.

The amount of addition of the pigment in the ink composition is preferably 2 to 15% by mass, and more preferably 3 to 12% by mass. If the amount of addition is less than 2% by mass, the image density may be lowered due to a decrease in the coloring power, or feathering or bleeding may be worsened due to a decrease in the viscosity. If the amount of addition is greater than 15% by mass, when an inkjet recording apparatus is left unused or the like, problems occur such as that the nozzles may easily dry up, non-ejection may occur, the ink penetrability may be decreased because the viscosity increases too much, the image density may be decreased because dots do not spread, or defective images may be formed.

Resin Particles

The ink composition according to the invention contains at least one kind of resin particles.

The resin particles are not particularly limited insofar as they have a desired glass transition temperature. Examples of the resin particles include resin particles of resin, such as thermoplastic acrylic, epoxy, polyurethane, polyether, polyamide, unsaturated polyester, phenol, silicone, or fluoro resin; polyvinyl resin, such as polyvinyl chloride, polyvinyl acetate, polyvinyl alcohol, or polyvinyl butyral; polyester resin, such as alkyd resin or phthalic resin, or copolymers or mixtures thereof.

In the invention, the resin particles preferably has a glass transition temperature of 80° C. or higher. When the ink composition contains resin particles having a glass transition temperature of 80° C. or higher, the fixability of the ink composition to a recording medium and the blocking resistance, offset resistance, and rubbing resistance of images to be formed can be effectively improved.

It is preferable that the resin particles have a function of fixing the ink composition, i.e., an image, by aggregating or destabilizing dispersion upon contact with a treatment liquid described later or a paper area on which the treatment liquid is dried to thereby increase the viscosity of ink. Such resin particles are preferably dispersed in at least one of water or an organic solvent.

According to the invention, it is preferable to set up the fixing temperature in the fixing step that will be described below, at less than 100° C. In this case, the glass transition temperature (Tg) of the resin particles is preferably 100° C. or higher, and more preferably 130° C. or higher. In the fixing step, fixing may be achieved at a heating temperature that is lower than the Tg measured with the resin particles alone, because of the plasticizing effect of a water-soluble organic solvent that will be described later, which is co-present with the resin particles in the ink composition. When the Tg of the resin particles and the fixing temperature are combined as described above, satisfactory offset resistance and blocking resistance are obtained, and speeding-up of the image forming process may be achieved.

The glass transition temperature of resin particles (polymer particles) can be controlled as appropriate by generally-used methods. For example, the glass transition temperature of resin particles can be controlled in a desired range by, selecting as appropriate the type of polymerizable groups of monomers used in the resin, the type and constituent ratio of substituents on the monomers, the molecular weight of polymer molecules contained in the resin particles, etc.

As the glass transition temperature, the measured Tg obtained by actual measurement is used. Specifically, the measured Tg refers to a value measured under usual measurement conditions using a differential scanning calorimeter (DSC) EXSTAR6220 (trade name) manufactured by SII Nanotechnology Inc. When the measurement is difficult due to decomposition of resin or the like, the calculated Tg obtained by calculation by the following calculation formula is used. The calculated Tg was obtained by calculation by Equation (1).

1/Tg=Σ(Xᵢ/Tgᵢ) (1)

In Equation (1), a polymer as a calculation target is assumed that n kinds of monomer components of i=1 to n are copolymerized. Xi is the weight fraction (ΣXᵢ=1) of the i-th monomer and Tgᵢ is the glass transition temperature (absolute temperature) of a homopolymer of the i-th monomer. Σ is the sum of i=1 to n. As the value (Tgi) of the glass transition temperature of a homopolymer of each monomer, the values described in “Polymer Handbook” (3rd Edition) (edited by J. Brandrup and E. H. Immergut (Wiley-Interscience, 1989)) are employed.

As the resin particles, particles of a self-dispersing polymer particle (hereinafter, may be referred to as self-dispersing polymer particles) are preferred and self-dispersing polymer particles having a carboxyl group are more preferred, from a view point of the ejection stability and the liquid stability (particularly, dispersion stability) in a case of using the pigment. The self-dispersing polymer particles mean particles of a water-insoluble polymer which can form a dispersed state in an aqueous medium by means of a functional group (particularly, an acidic group or a salt thereof) included in the polymer per se in the absence of an additional surfactant, and are water-insoluble polymer particles which do not contain an additional separate emulsifier.

Further, when the self-dispersing polymer is used, delaying in aggregation caused by the separate dispersant may be less likely to occur. Therefore, using the self-dispersing polymer is preferable from the viewpoint of aggregating properties, and is also preferable since a high resolution image may be formed when high speed recording is employed.

The meaning of “dispersed state” includes an emulsified state where the water-insoluble polymer is dispersed in a liquid state in an aqueous medium (emulsion) and a dispersed state where the water-insoluble polymer is dispersed in a solid state in the aqueous medium (suspension).

The water-insoluble polymer in the invention is preferably such a water-insoluble polymer that can form a dispersed state where the water-insoluble polymer is dispersed in a solid state, from a view point of the aggregation speed and the fixing property when it is used in a liquid composition.

The dispersed state of the self-dispersing polymer particles means such a state where stable presence of a dispersed state can be confirmed visually at 25° C. for at least one week after mixing and stirring a solution in which 30 g of a water-insoluble polymer is dissolved into 70 g of an organic solvent (for example, methyl ethyl ketone), a neutralizing agent capable of neutralizing a salt-forming group of the water-insoluble polymer to 100% (sodium hydroxide when the salt forming group is anionic or acetic acid when the group is cationic), and 200 g of water (apparatus: a stirrer equipped with a stirring blade, number of rotation: 200 rpm, 30 min, 25° C.), and then removing the organic solvent from the liquid mixture.

The water-insoluble polymer means a polymer which is dissolved in an amount (amount of dissolution) of 10 g or less when the polymer is dried at 105° C. for 2 hours and then dissolved in 100 g of water at 25° C. The amount of dissolution is, preferably, 5 g or less and, more preferably, 1 g or less. The amount of dissolution is the amount of dissolution when the polymer is neutralized to 100% with sodium hydroxide or acetic acid in accordance with the kind of the salt-forming group of the water-insoluble polymer.

The aqueous medium contains water and may optionally contain a hydrophilic organic solvent. In the invention, the aqueous medium preferably includes water and the hydrophilic organic solvent in an amount of 0.2% by mass or less relative to water and, more preferably, the aqueous medium consists of water.

The main chain skeleton of the resin used in the resin particles in the invention is not particularly limited and, for example, a vinyl polymer or a condensated type polymer (epoxy resin, polyester, polyurethane, polyamide, cellulose, polyether, polyurea, polyimide, polycarbonate, etc.) can be used. Among them, a vinyl polymer is particularly preferred. From the viewpoint of dispersion stability of the resin particles, (meth)acrylic resin particles are more preferred.

(Meth)acrylic resin means methacrylic resin or acrylic resin.

Preferred examples of the vinyl polymer and the monomer used for the vinyl polymer include those described in JP-A Nos. 2001-181549 and 2002-88294. Further, vinyl polymers introduced with a dissociating group to a terminal end of a polymer chain by radical polymerization of a vinyl monomer using a chain transfer agent, a polymerization initiator, or an iniferter having a dissociating group (or a substituent that can be induced to the dissociating group) or by ionic polymerization using a compound having a dissociating group (or substituent that can be induced to the dissociating group) to an initiator or a terminator can also be used.

Preferred examples of condensated type polymers and monomers used for the condensated type polymers include those described in JP-A No. 2001-247787.

The self-dispersing polymer particles in the invention preferably contain a water-insoluble polymer containing a hydrophilic constituent unit and, as a hydrophobic constituent unit, at least one constituent unit derived from an alicyclic monomer, from a viewpoint of the self-dispersibility. In addition to these, the water-insoluble polymer may further include a constituent unit derived from an aromatic group-containing monomer.

The hydrophilic constituent unit is not particularly limited so long as it is derived from a hydrophilic group-containing monomer and it may be either a unit derived from one kind of hydrophilic group-containing monomer or a unit derived from two or more kinds of hydrophilic group-containing monomers. The hydrophilic group is not particularly limited and it may be either a dissociating group or a nonionic hydrophilic group.

The hydrophilic group is preferably a dissociating group from a view point of promoting the self-dispersibility and a view point of stability of the formed emulsified or dispersed state and, more preferably, an anionic dissociating group. Examples of the dissociating group include a carboxyl group, a phosphoric acid group, and a sulfonic acid group and, among them, the carboxyl group is preferred from a viewpoint of the fixing property when the ink composition is formed.

The hydrophilic group-containing monomer in the invention is preferably a dissociating group-containing monomer and, preferably, a dissociating group-containing monomer having a dissociating group and an ethylenically unsaturated bond from a viewpoint of the self-dispersibility and the aggregation property.

Examples of the dissociating group-containing monomer include an unsaturated carboxylic acid monomer, an unsaturated sulfonic acid monomer, and an unsaturated phosphoric acid monomer.

Specific examples of the unsaturated carboxylic acid monomer include acrylic acid, methacrylic acid, crotonic acid, itaconic acid, maleic acid, fumaric acid, citraconic acid, and 2-methacryloyloxy methyl succinic acid, etc. Specific examples of the unsaturated sulfonic acid monomer include styrene sulfonic acid, 2-acrylamide-2-methylpropane sulfonic acid, 3-sulfopropyl(meth)acrylate, and bis(3-sulfopropyl)-itaconic acid ester. Specific examples of the unsaturated phosphoric acid monomer include vinyl phosphonic acid, vinyl phosphate, bis(methacryloyloxyethyl) phosphate, diphenyl-2-acryloyloxyethyl phosphate, diphenyl-2-methacryloyloxyethyl phosphate, and dibutyl-2-acryloyloxyethyl phosphate.

Among the dissociating group-containing monomers, the unsaturated carboxylic acid monomer is preferred and, at least one of acrylic acid or methacrylic acid are more preferred from a viewpoint of the dispersion stability and the ejection stability.

Examples of monomers having a nonionic hydrophilic group include: ethylenically unsaturated monomers containing a (poly)ethyleneoxy group or a polypropyleneoxy group, such as 2-methoxy ethyl acrylate, 2-(2-methoxyethoxy)ethyl acrylate, 2-(2-methoxyethoxy)ethyl methacrylate, ethoxytriethylene glycol methacrylate, methoxypolyethylene glycol (molecular weight of from 200 to 1,000) monomethacrylate, or polyethylene glycol (molecular weight of from 200 to 1,000) monomethacrylate; and ethylenically unsaturated monomers containing a hydroxyl group, such as hydroxymethyl(meth)acrylate, 2-hydroxyethyl(meth)acrylate, 2-hydroxypropyl(meth)acrylate, 4-hydroxybutyl(meth)acrylate, hydroxypentyl(meth)acrylate, or hydroxyhexyl(meth)acrylate.

The monomers containing a nonionic hydrophilic group are more preferably an ethylenically unsaturated monomer having alkyl ether at a terminal than an ethylenically unsaturated monomer having a hydroxyl group at a terminal from the viewpoint of the stability of the particles and the content of water-soluble components.

With respect to the hydrophilic constituent unit in the invention, preferable examples of the polymer include those containing only a hydrophilic unit containing an anionic dissociating group as a hydrophilic constituent unit and those containing both a hydrophilic constituent unit containing an anionic dissociating group and a hydrophilic constituent unit containing a nonionic hydrophilic group.

Preferable examples of the polymer further include those containing two or more kinds of hydrophilic units each containing an anionic dissociating group, and those containing two or more kinds of hydrophilic constituent units including one or more kinds of hydrophilic constituent units each containing an anionic dissociating group and one or more kinds of hydrophilic constituent units each containing a nonionic hydrophilic group in combination.

The content of the hydrophilic constituent units in the self-dispersing polymer is preferably 25% by mass or lower, more preferably from 1% by mass to 25% by mass, still more preferably from 2% by mass to 23% by mass, and particularly preferably from 4% by mass to 20% by mass, from the viewpoint of viscosity and stability over time of the ink composition.

When two or more kinds of hydrophilic constituent units are contained, a total content of the hydrophilic constituent units is preferably in the range mentioned above.

A content of the constituent unit containing an anionic dissociating group in the self-dispersing polymer is preferably in a range by which the acid value is in a preferable range described below.

A content of the constituent unit having a nonionic hydrophilic group is preferably from 0 to 25% by mass, more preferably from 0 to 20% by mass, and particularly preferably from 0 to 15% by mass from the viewpoint of ejection stability and stability over time.

The self-dispersing polymer particles in the invention preferably contain a polymer containing a carboxyl group and more preferably contain a polymer containing a carboxyl group and having an acid value of from 25 to 100 mgKOH/g, from the viewpoint of self-dispersibility and an aggregation rate when contacting the treatment liquid which will be described below. Furthermore, the acid value is more preferably from 25 to 80 mgKOH/g and particularly preferably from 30 to 65 mgKOH/g from the viewpoint of self-dispersibility and an aggregation rate when contacting the treatment liquid.

In particular, when the acid value is 25 mgKOH/g or more, the stability of self-dispersibility becomes favorable and when the acid value is 100 or lower, aggregation properties increase.

The alicyclic monomer is not particularly limited insofar as it is a compound containing an alicyclic hydrocarbon group and a polymerizable group, and is preferably alicyclic(meth)acrylate from the viewpoint of dispersion stability.

The alicyclic(meth)acrylate has a structural portion derived from (meth)acrylic acid and a structural portion derived from alcohol, and the structural portion derived from alcohol contains at least one unsubstituted or substituted alicyclic hydrocarbon group. The alicyclic hydrocarbon group may be the structural portion derived from alcohol itself or may be bonded to the structural portion derived from alcohol via a linking group.

The “alicyclic(meth)acrylate” refers to methacrylate or acrylate having an alicyclic hydrocarbon group.

The alicyclic hydrocarbon group is not particularly limited insofar as it contains a cyclic non-aromatic hydrocarbon group. Examples thereof include a monocyclic hydrocarbon group, a bicyclic hydrocarbon group, and a polycyclic hydrocarbon group of tri- or higher cycle.

Examples of the alicyclic hydrocarbon group include cycloalkyl groups, such as a cyclopentyl group or a cyclohexyl group, a cyclo alkenyl group, a bicyclo hexyl group, a norbornyl group, an isobornyl group, a dicyclopentanil group, a dicyclopentenyl group, an adamanthyl group, a decahydronaphthalenyl group, a perhydro fluorenyl group, and a tricyclo[5.2.1.0^{2,6}]decanyl group, and bicyclo[4.3.0]nonane.

The alicyclic hydrocarbon group may further have a substituent. Examples of the substituent include an alkyl group, an alkenyl group, an aryl group, an aralkyl group, an alkoxy group, a hydroxy group, a primary amino group, a secondary amino group, a tertiary amino group, an alkyl carbonyl group, an aryl carbonyl group, and a cyano group.

The alicyclic hydrocarbon group may further form a condensed ring. The alicyclic hydrocarbon group in the invention preferably has an alicyclic hydrocarbon group portion having 5 to 20 carbon atoms from the viewpoint of viscosity and solubility.

Examples of a linking group for bonding the alicyclic hydrocarbon group to the structural portion derived from alcohol include an alkyl group, an alkenyl group, an alkylene group, an aralkyl group, an alkoxy group, a mono- or oligo-ethylene glycol group, and a mono- or oligo-propylene glycol group, each having 1 to 20 carbon atoms.

Specific example of the alicyclic(meth)acrylate in the invention are shown below, but the invention is not limited thereto. One kind of these compounds may be used singly, or two or more kinds may be used in combination.

Examples of the monocyclic(meth)acrylate include cycloalkyl(meth)acrylate having a cycloalkyl group having 3 to 10 carbon atoms, such as cyclopropyl(meth)acrylate, cyclobutyl(meth)acrylate, cyclopentyl(meth)acrylate, cyclohexyl(meth)acrylate, cycloheptyl(meth)acrylate, cyclooctyl(meth)acrylate, cyclononyl(meth)acrylate, and cyclodecyl(meth)acrylate.

Examples of the bicyclic(meth)acrylate include isobornyl(meth)acrylate and norbornyl(meth)acrylate.

Examples of the tricyclic(meth)acrylate include adamanthyl(meth)acrylate, dicyclopentanil(metha)acrylate, and dicyclopentenyloxyethyl(meth)acrylate.

Among the above, from the viewpoint of the dispersion stability of the self-dispersing polymer particles, fixability, and blocking resistance, at least either one of the bicyclic(meth)acrylate or the polycyclic(meth)acrylate of tri- or higher cycle is preferable and at least one selected from isobornyl(meth)acrylate, adamanthyl(meth)acrylate, and dicyclopentanil(meth)acrylate is more preferable.

In the invention, the content of the constituent unit derived from the alicyclic(meth)acrylate contained in the self-dispersing polymer particles is preferably from 20% by mass to 90% by mass and more preferably from 40% by mass to 90% by mass from the viewpoint of the stability of a self-dispersion state, stabilization of the particle shape in an aqueous medium due to hydrophobic interaction of alicyclic hydrocarbon groups, and reduction in the amount of water-soluble components due to appropriate hydrophobizing of particles. The content thereof is particularly preferably from 50% by mass to 80% by mass.

When the content of the constituent unit derived from alicyclic(meth)acrylate is 20% by mass or more, fixability and blocking may be improved. In contrast, when the constituent unit derived from alicyclic(meth)acrylate is 90% by mass or lower, the stability of polymer particles may be improved.

When a constituent unit derived from an aromatic group-containing monomer is included, the aromatic group-containing monomer is not particularly limited so long as it is a compound containing an aromatic group and a polymerizable group. The aromatic group may be either a group derived from an aromatic hydrocarbon or a group derived from an aromatic heterocyclic ring. In the invention, the aromatic group is preferably an aromatic group derived from the aromatic hydrocarbon, from a viewpoint of particle shape stability in the aqueous medium.

The polymerizable group may be either a polycondensating polymerizable group or an addition polymerizing polymerizable group. The polymerizable group is preferably an addition polymerizing polymerizable group, and more preferably, a group containing an ethylenically unsaturated bond from a viewpoint of particle shape stability in the aqueous medium.

The aromatic group-containing monomer in the invention is preferably a monomer containing an aromatic group derived from an aromatic hydrocarbon and an ethylenically unsaturated bond. One kind of the aromatic group-containing monomer may be used singly or two or more kinds of the aromatic group-containing monomers may be used in combination.

Examples of the aromatic group-containing monomer include phenoxyethyl(meth)acrylate, benzyl(meth)acrylate, phenyl(meth)acrylate, and styrenic monomer. Among them, from a viewpoint of the balance between the hydrophilicity and the hydrophobicity of the polymer chain and the ink fixing property, an aromatic group-containing (meth)acrylate monomer is preferred, and at least one selected from the group consisting of phenoxyethyl(meth)acrylate, benzyl(meth)acrylate, and phenyl(meth)acrylate is more preferable and, phenoxyethyl(meth)acrylate and benzyl(meth)acrylate are still more preferred.

“(Meth)acrylate” means acrylate or methacrylate, “(meth)acrylamide” means acrylamide or methacrylamide, and “(meth)acrylic” means acrylic or methacrylic.

When a styrene monomer is used as an aromatic group-containing monomer, the content of a constituent unit derived from a styrene monomer is preferably 20% by mass or lower, more preferably 10% by mass or lower, and still more preferably 5% by mass or lower, from the viewpoint of stability of self-dispersing polymer particles in which the monomer is used. It is further preferable that the self-dispersing polymer do not contain the constituent unit derived from a styrene monomer.

Here, the styrene monomer refers to styrene, substituted styrene (α-methyl styrene, chlorostyrene, etc.), or a styrene macromer having a polystyrene structural unit.

The self-dispersing polymer particles in the invention may optionally include, for example, as a hydrophobic constituent unit, additional constituent unit(s) as well as a constituent unit derived from an aromatic group-containing monomer, in addition to a constituent unit derived from an alicyclic monomer.

The monomer which may be used for forming the additional constituent unit (hereinafter, may also be referred to as an “additional copolymerizable monomer”) is not particularly limited so long as it is a monomer copolymerizable with the hydrophilic group-containing monomer, the aromatic group-containing monomer and the alicyclic monomer. An alkyl group-containing monomer is preferred from a viewpoint of the flexibility of the polymer skeleton or easiness in control for the glass transition temperature (Tg).

Examples of the alkyl group-containing monomer include alkyl(meth)acrylates such as methyl(meth)acrylate, ethyl(meth)acrylate, isopropyl(meth)acrylate, n-propyl(meth)acrylate, n-butyl(meth)acrylate, isobutyl(meth)acrylate, t-butyl(meth)acrylate, hexyl(meth)acrylate, and ethylhexyl(meth)acrylate; ethylenically unsaturated monomers having a hydroxyl group such as hydroxymethyl(meth)acrylate, 2-hydroxyethyl(meth)acrylate, 2-hydroxypropyl(meth)acrylate, 4-hydroxybutyl(meth)acrylate, hydroxypentyl(meth)acrylate, and hydroxyhexyl(meth)acrylate; dialkylamino alkyl(meth)acrylates such as dimethylaminoethyl(meth)acrylate; (meth)acrylamides, for example, N-hydroxyalkyl(meth)acrylamide such as N-hydroxymethyl(meth)acrylamide, N-hydroxyethyl(meth)acrylamide, and N-hydroxybutyl(meth)acrylamide; and N-alkoxyalkyl(meth)acrylamides such as N-methoxymethyl(meth)acrylamide, N-ethoxymethyl(meth)acrylamide, N-(n-, iso)butoxymethyl(meth)acrylamide, N-methoxyethyl(meth)acrylamide, N-ethoxyethyl(meth)acrylamide, and N-(n-, iso)butoxyethyl(meth)acrylamide.

In particular, from the viewpoint of the flexibility of a polymer skeleton or ease of control of the glass transition temperature (Tg) and from the viewpoint of dispersion stability of a self-dispersing polymer, at least one of (meth)acrylates containing a chain alkyl group having 1 to 8 carbon atoms is preferable, (meth)acrylates containing a chain alkyl group having 1 to 4 carbon atoms are more preferable, and methyl(meth)acrylate or ethyl(meth)acrylate is particularly preferable. Here, the chain alkyl group refers to an alkyl group having a straight chain or a branched chain.

In the invention, one kind of the additional copolymerizable monomers may be used singly or two or more kinds of the additional copolymerizable monomers may be used in combination.

When the self-dispersing polymer particles contain the additional constituent units, the content thereof is preferably from 10% by mass to 80% by mass, more preferably from 15% by mass to 75% by mass, and particularly preferably from 20% by mass to 70% by mass. When two or more kinds of monomers are used in combination for forming the additional constituent unit(s), the total content thereof is preferably in the range described above.

The self-dispersing polymer in the invention is also preferably a polymer obtained by polymerizing at least three kinds of substances of at least one alicyclic(meth)acrylate, an additional copolymerizable monomer including an aromatic group-containing (meth)acrylate, and a hydrophilic group-containing monomer, from the viewpoint of dispersion stability, and more preferably a polymer obtained by polymerizing at least three kinds of substances of at least one alicyclic(meth)acrylate, (meth)acrylate containing a straight chain or branched chain alkyl group having 1 to 8 carbon atoms, and a hydrophilic group-containing monomer.

In the invention, the self-dispersing polymer is preferably a self-dispersing polymer which does not substantially contain a constituent unit having a substituent having high hydrophobicity such as a constituent unit derived from (meth)acrylate having a straight chain or branched chain alkyl group having 9 or more carbon atoms, a constituent unit derived from an aromatic group-containing macromonomer or the like, and the self-dispersing polymer is more preferably a self-dispersing polymer which does not contain a constituent unit having a substituent having high hydrophobicity such as a constituent unit derived from (meth)acrylate having a straight chain or branched chain alkyl group having 9 or more carbon atoms, a constituent unit derived from an aromatic group-containing macromonomer or the like, from the viewpoint of dispersion stability.

The self-dispersing polymer in the invention may be a random copolymer in which each constituent unit is irregularly introduced or a block copolymer in which each constituent unit is regularly introduced. In the case of a block copolymer, each constituent unit may be synthesized in any introduction order and the same constituent may be used twice or more. A random copolymer is preferable in terms of versatility and manufacturability.

The molecular weight of the self-dispersing polymer in the invention is, preferably, from 3,000 to 200,000 and, more preferably, from 5,000 to 150,000 and, further preferably, from 10,000 to 100,000 as the weight average molecular weight. Further, the self-dispersing polymer preferably has an acid value of from 25 to 100 mgKOH/g and a weight average molecular weight of from 3,000 to 200,000, and the self-dispersing polymer more preferably has an acid value of from 25 to 95 mgKOH/g and a weight average molecular weight of from 5,000 to 150,000. When the weight average molecular weight is 3,000 or more, the amount of the water-soluble component can be suppressed effectively. Further, when the weight average molecular weight is 200,000 or less, the self-dispersion stability can be increased.

The weight average molecular weight is measured by gel permeation chromatography (GPC). In GPC, HLC-8020GPC (manufactured by Tosoh Corporation) is used, and 3 pieces of column of TSKgel Super HZM-H, TSK gel Super HZ4000 and TSK gel Super HZ200 (trade names, manufactured by Tosoh Corporation, 4.6 mm ID×15 cm) are used, and TI-IF (tetrahydrofuran) is used as an eluate.

It is preferable that the self-dispersing polymer in the invention contain constituent unit(s) derived from alicyclic (meth)acrylate(s) (preferably structural units derived from at least one of isobornyl(meth)acrylate, adamanthyl(meth)acrylate, and dicyclopentanyl(meth)acrylate) in a proportion of from 15% by mass to 80% by mass of the total mass of the self-dispersing polymer particles as a copolymerization ratio, have an acid value of from 25 to 100 mgKOH/g, and a weight average molecular weight of from 3000 to 200,000 from the viewpoint of controlling hydrophilic and hydrophobic properties of the polymers.

It is also preferable that the self-dispersing polymer contain constituent unit(s) derived from alicyclic (meth)acrylate(s) (preferably structural unit(s) derived from at least one of isobornyl(meth)acrylate, adamanthyl(meth)acrylate, and dicyclopentanyl(meth)acrylate) in a proportion of from 15% by mass to 80% by mass of the total mass of the self-dispersing polymer particles as a copolymerization ratio, a constituent unit derived from carboxyl group-containing monomer(s), and a constituent unit derived from alkyl group-containing monomer(s) (preferably a structural unit derived from an alkyl ester of (meth)acrylic acid) from the viewpoint of controlling hydrophilic and hydrophobic properties of the polymers. It is more preferable that the self-dispersing polymers contain structural unit(s) derived from at least one of isobornyl (meth)acrylate, adamanthyl (meth)acrylate, and dicyclopentanyl(metha)acrylate in a proportion of from 15 to 80% by mass as a copolymerization ratio, a constituent unit derived from carboxyl group-containing monomer(s), and a constituent unit derived from alkyl group-containing monomer(s) (preferably a structural unit derived from an alkyl ester having 1 to 4 carbon atoms of (meth)acrylic acid), have an acid value of from 25 to 95 mgKOH/g, and have a weight average molecular weight of from 5,000 to 150,000.

It is also preferable that the self-dispersing polymer of the invention be a vinyl polymer containing structure(s) derived from alicyclic (meth)acrylate(s) (preferably structural unit(s) derived from at least one of isobornyl(meth)acrylate, adamanthyl(meth)acrylate, and dicyclopentanyl(meth)acrylate) in a proportion of from 20% by mass to 90% by mass as a copolymerization ratio, a structure derived from dissociating group-containing monomer(s), at least one structure derived from (meth)acrylate(s) containing a chain alkyl group having 1 to 8 carbon atoms, have an acid value of from 20 to 120 mgKOH/g, have a total content of hydrophilic structural units of 25% by mass or lower, and have a weight average molecular weight of from 3,000 to 200,000, from the viewpoint of controlling hydrophilic and hydrophobic properties of the polymer. It is more preferable that the self-dispersing polymer of the invention be a vinyl polymer containing a structure derived from polycyclic (meth)acrylate(s) having two or three rings (preferably a structural unit derived from at least one of isobornyl (meth)acrylate, adamanthyl (meth)acrylate, and dicyclopentanyl(metha)acrylate) in a proportion of from 30% by mass to 90% by mass as a copolymerization ratio, a structure derived from (meth)acrylate(s) containing a chain alkyl, group having 1 to 4 carbon atoms in a proportion of from 10% by mass to 80% by mass as a copolymerization ratio, and a structure derived from carboxyl group-containing monomer(s) in such an amount that the acid value is in the range of from 25 to 100 mgKOH/g, have a total content of hydrophilic structural units of 25% by mass or lower, and have a weight average molecular weight of from 10000 to 200,000. It is particularly preferable that the self-dispersing polymer of the invention be a vinyl polymer containing a structure derived from polycyclic (meth)acrylate(s) having two or three rings (preferably a structural unit derived from at least one of isobornyl (meth)acrylate, adamanthyl (meth)acrylate, and dicyclopentanyl(metha)acrylate) in a proportion of from 40% by mass to 80% by mass as a copolymerization ratio, a structure derived at least from methyl(meth)acrylate(s) or ethyl (meth)acrylate(s) in a proportion of from 20% by mass to 70% by mass as a copolymerization ratio, and a structure derived from acrylic acid(s) or methacrylic acid(s) in such an amount that the acid value is in the range of from 30 to 80 mgKOH/g, have a total content of hydrophilic structural units of 25% by mass or lower, and have a weight average molecular weight of from 30,000 to 150,000.

Examples of polymers used in the resin particles include the following alicyclic group-containing polymers, but the invention is not limited to the following examples. The ratio in the brackets represents the mass ratio of copolymerization components. When the glass transition temperature is “calculated Tg”, the glass transition temperature is a value obtained by the calculation according to Equation (1) previously described above using a Tg value of a homopolymer of each of the following monomers. That is, Tg of a homopolymer of methyl methacrylate is 105° C., Tg of a homopolymer of isobornyl methacrylate is 156° C., Tg of a homopolymer of benzyl methacrylate is 54° C., Tg of a homopolymer of methacrylic acid is 130° C., Tg of a homopolymer of adamantyl methacrylate is 140° C., and Tg of a homopolymer of dicyclopentanyl methacrylate is 128° C.
Methyl methacrylate/isobornyl methacrylate/methacrylic acid copolymer (20/72/8), Glass transition temperature Tg: 180° C.
Methyl methacrylate/isobornyl methacrylate/methacrylic acid copolymer (30/62/8), Glass transition temperature Tg: 170° C.
Methyl methacrylate/isobornyl methacrylate/methacrylic acid copolymer (40/52/8), Glass transition temperature Tg: 160° C.
Methyl methacrylate/isobornyl methacrylate/methacrylic acid copolymer (50/42/8), Glass transition temperature Tg: 150° C.
Methyl methacrylate/isobornyl methacrylate/benzyl methacrylate/methacrylic acid copolymer (30/50/14/6), Glass transition temperature Tg: 123° C.
Methyl methacrylate/dicyclopentanyl methacrylate/methacrylic acid copolymer (40/50/10), Glass transition temperature Tg: 130° C.
Methyl methacrylate/dicyclopentanyl methacrylate/phenoxy ethyl methacrylate/methacrylic acid copolymer (30/50/14/6), Glass transition temperature Tg: 101° C.
Methyl methacrylate/isobornyl methacrylate/methoxypolyethylene glycol methacrylate (n=2)/methacrylic acid copolymer (30/54/10/6), Glass transition temperature Tg: 110° C.
Methyl methacrylate/dicyclopentanyl methacrylate/methoxypolyethylene glycol methacrylate (n=2)/methacrylic acid copolymer (54/35/5/6), Glass transition temperature Tg: 100° C.
Methyl methacrylate/adamantyl methacrylate/methoxypolyethylene glycol methacrylate (n=23)/methacrylic acid copolymer (30/50/15/5), Glass transition temperature Tg: 112° C.
Methyl methacrylate/isobornyl methacrylate/dicyclopentanyl methacrylate/methacrylic acid copolymer (20/50/22/8), Glass transition temperature Tg: 139° C.
Ethyl methacrylate/cyclohexyl methacrylate/acrylic acid copolymer (50/45/5), Glass transition temperature Tg: 67° C.
Isobutylmethacrylate/cyclohexyl methacrylate/acrylic acid copolymer (40/50/10), Glass transition temperature Tg: 70° C.
n-butyl methacrylate/cyclohexyl methacrylate/styrene/acrylic acid copolymer (30/55/10/5), Glass transition temperature Tg: 86° C.
Methyl methacrylate/dicyclopentenyloxyethyl methacrylate/methacrylic acid copolymer (40/52/8), Glass transition temperature Tg: 78° C.
Lauryl methacrylate/dicyclopentenyloxyethyl methacrylate/methacrylic acid copolymer (3/87/10), Glass transition temperature Tg: 53° C.

The method of producing a water-insoluble polymer that is used in the resin particle in the invention is not particularly limited. Examples of the method of producing the water-insoluble polymer include a method of performing emulsion polymerization under the presence of a polymerizable surfactant thereby covalently-bonding the surfactant and the water-insoluble polymer, and a method of copolymerizing a monomer mixture containing the hydrophilic group-containing monomer and the aromatic group-containing monomer by a known polymerization method such as a solution polymerization method or a bulk polymerization method. Among the polymerization methods described above, the solution polymerization method is preferred and a solution polymerization method in which an organic solvent is used is more preferred from a viewpoint of aggregation speed and the stability of droplet ejection of the ink composition.

From a viewpoint of the aggregation speed, it is preferred that the self-dispersing polymer particles in the invention contain a polymer synthesized in an organic solvent, and the polymer has a carboxyl group (the acid value is preferably from 20 to 100 mgKOH/g), in which the carboxyl groups of the polymer are partially or entirely neutralized and the polymer is prepared as a polymer dispersion in a continuous phase of water. That is, the self-dispersing polymer particle in the invention is prepared by a method including a step of synthesizing the polymer in the organic solvent and a dispersion step of forming an aqueous dispersion in which at least a portion of the carboxyl groups of the polymer is neutralized.

The dispersion step preferably includes the following step (1) and step (2).

Step (1): stirring a mixture containing a polymer (water-insoluble polymer), an organic solvent, a neutralizing agent, and an aqueous medium.

Step (2): removing the organic solvent from the mixture.

The step (1) preferably a treatment that includes at first dissolving the polymer (water-insoluble polymer) in the organic solvent and then gradually adding the neutralizing agent and the aqueous medium, and mixing and stirring the mixture to obtain a dispersion. By adding the neutralizing agent and the aqueous medium to the solution of the water-insoluble polymer dissolved in the organic solvent, self-dispersing polymer particles having a particle size that enables higher storage stability can be obtained without requiring strong sharing force.

The method for stirring the mixture is not particularly limited and a mixing and stirring apparatus that is used generally can be used, and optionally, a disperser such as a ultrasonic disperser or a high pressure homogenizer can be used.

Preferable examples of the organic solvent include alcohol type solvents and ketone type solvents

Examples of the alcohol type solvent include isopropyl alcohol, n-butanol, t-butanol, and ethanol. Examples of the ketone type solvent include acetone, methyl ethyl ketone, diethyl ketone, and methyl isobutyl ketone. Examples of the ether type solvent include dibutyl ether and dioxane. Among the solvents, the ketone type solvent such as methyl ethyl ketone and the alcohol type solvent such as isopropyl alcohol are preferred. Further, with an aim of moderating the change of polarity at the phase transfer from an oil system to an aqueous system, combined use of isopropyl alcohol and methyl ethyl ketone is also preferred. By the combined use of the solvents, self-dispersing polymer particles of small particle size with no aggregation settling or fusion between particles to each other and having high dispersion stability may be obtained.

The neutralizing agent is used to partially or entirely neutralize the dissociating groups so that the self-dispersing polymer can form a stable emulsified or dispersed state in water. In a case where the self-dispersing polymer of the invention has an anionic dissociating group (for example, carboxyl group) as the dissociating group, examples of the neutralizing agent to be used include basic compounds such as organic amine compounds, ammonia, and alkali metal hydroxides. Examples of the organic amine compounds include monomethyl amine, dimethyl amine, trimethyl amine, monoethyl amine, diethyl amine, triethyl amine, monopropyl amine, dipropyl amine, monoethanol amine, diethanol amine, triethanol amine, N,N-dimethyl-ethanol amine, N,N-diethyl-ethanol amine, 2-dimethylamino-2-methyl-1-propanol, 2-amino-2-methyl-1-propanol, N-methyldiethanol amine, N-ethyldiethanol amine, monoisopropanol amine, diisopropanol amine, and triisopropanol amine, etc. Examples of the alkali metal hydroxide include lithium hydroxide, sodium hydroxide and potassium hydroxide. Among them, sodium hydroxide, potassium hydroxide, triethylamine, and triethanol amine are preferred from a viewpoint of the stabilization of dispersion of the self-dispersing polymer particles of the invention into water.

The basic compound is used preferably in an amount of from 5 to 120 mol %, more preferably, from 10 to 110 mol %, and further preferably, from 15 to 100 mol %, relative to 100 mol % of the dissociating groups. When the basic compound is used in an amount of 15 mol % or more, the effect of stabilizing the dispersion of the particles in water may be obtained and when the basic compound is in an amount of 100% or less, the effect of decreasing the water-soluble component may be provided.

In the step (2), an aqueous dispersion of the self-dispersing polymer particles can be obtained by phase transfer to the aqueous system by distilling off the organic solvent from the dispersion obtained in the step (1) by a common method such as distillation under a reduced pressure. In the obtained aqueous dispersion, the organic solvent has been substantially removed and the amount of the organic solvent is preferably from 0.2% by mass or less and, more preferably, 0.1% by mass or less.

The average particle size of the resin particles is, as a volume average particle size, preferably in the range of 10 nm to 1 μm, more preferably in the range of from 10 nm to 200 nm, even more preferably in the range of from 10 nm to 100 nm, and particularly preferably in the range of from 10 nm to 50 nm. When the volume average particle size is 10 nm or more, production suitability may be enhanced, and when the volume average particle size is 1 μm or less, storage stability may be enhanced.

The particle size distribution of the resin particles is not particularly limited, and any of those particles having a broad particle size distribution or those particles having a monodisperse particle size distribution may be used. Two or more kinds of water-insoluble particles may be used as mixtures.

The average particle size and particle size distribution of the resin particles are determined by measuring the volume average particle size by a dynamic light scattering method, using a NANOTRACK particle size distribution analyzer (model name: UPA-EX 150, manufactured by Nikkiso Co., Ltd.).

One kind of the resin particles (particularly, for example, self-dispersing polymer particles) can be used singly or two or more kinds thereof may be used in combination. The content of the resin particles in the ink composition is preferably 0.5 to 20% by mass, more preferably from 2% by mass to 20% by mass, and still more preferably from 3% by mass to 15% by mass, relative to the total mass of the ink composition.

The content of the resin particles relative to the total mass of the solid content in the ink composition is preferably 40% by mass or more. When the proportion relative to the total mass of the solid content is in the range mentioned above, in a case where high speed recording is performed using, for example, a single pass method, sufficient aggregation properties for obtaining high resolution images may be obtained and the occurrence of blocking and offset can be effectively suppressed. Moreover, the content of the resin particles in the ink composition is more preferably from 40% by mass to 90% by mass, still more preferably from 40% by mass to 80% by mass, and most preferably from 50% by mass to 70% by mass, relative to the total mass of the solid content in the ink composition.

Fluorine-Based Surfactant

The ink composition according to the invention contains a fluorine-based surfactant from the viewpoint that the dynamic surface tension may be appropriately adjusted, and stable ejection may be achieved in an inkjet system. The surfactant may be used as a surface tension adjusting agent. A compound having a structure that contains a hydrophilic moiety and a hydrophobic moiety together in the molecule, or the like may be effectively used as the surface tension adjusting agent. The fluorine-based surfactant may be a compound derived via an intermediate having a perfluoroalkyl group, using a technique such as electrolytic fluorination, telomerization or oligomerization. Examples of the fluorine-based surfactant include perfluoroalkylsulfonates, perfluoroalkylcarboxylates, perfluoroalkyl ethylene oxide adducts, perfluoroalkyltrialkylammonium salts, perfluoroalkyl group-containing oligomers, and perfluoroalkyl phosphoric acid esters.

Suitable examples of the fluorine-based surfactant include compounds represented by the following formula (I) to formula (III).

CF₃CF₂(CF₂CF₂)ₘ—CH₂CH₂O(CH₂CH₂O)ₙH Formula (I)

In the formula (I), m represents an integer of from 0 to 10; and n represents an integer of from 1 to 40.

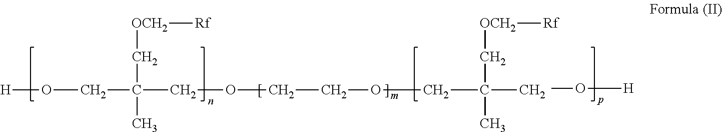

In the formula (II), Rf represents a fluorine-containing group, and is particularly preferably a perfluoroalkyl group.

The perfluoroalkyl group preferably has 1 to 10 carbon atoms, and more preferably has from 1 to 3 carbon atoms. An example may be —CₙF₂ₙ₋₁ (wherein n represents an integer of from 1 to 10). Examples of the perfluoroalkyl group include —CF₃, —CF₂CF₃, —C₃F₇ and —C₄F₉, and among these, —CF₃ and —CF₂CF₃ are particularly preferred.

m, n and p each represent an integer, and n is preferably from 1 to 4, m is preferably from 6 to 25, and p is preferably from 1 to 4.

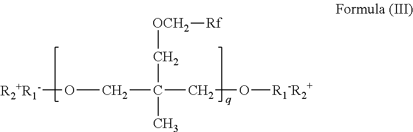

In the formula (III), Rf represents a fluorine-containing group, and a perfluoroalkyl group similar to the group of formula (II) is preferred. Suitable examples include —CF₃, —CF₂CF₃, —C₃F₇ and —C₄F₉.

R₂⁺ represents a cationic group, and examples include a quaternary ammonium group; an ion of alkali metal such as sodium or potassium; triethylamine, and triethanolamine. Among these, a quaternary ammonium group is particularly preferred.

R₁⁻ represents an anionic group, and examples include COO⁻, SO₃⁻, SO₄⁻ and PO₄⁻. q is preferably from 1 to 6.

As the fluorine-based surfactant, an appropriately synthesized product may be used, or a commercially available product may be used. Furthermore, a combination of plural products may also be used.

Examples of commercially available products include SURFLON S-111, S-112, S-113, S-121, S-131, S-132, S-141 and S-145 (all trade names, manufactured by Asahi Glass Co., Ltd.); FULLARD FC-93, FC-95, FC-98, FC-129, FC-135, FC-170 C, FC-430 and FC-431 (all trade names, manufactured by Sumitomo 3M, Ltd.); MEGAFAC F-470, F1405 and F-474 (all trade names, manufactured by Dainippon Ink & Chemicals, Inc.); ZONYL TBS, FSP, FSA, FSN-100, FSN, FSO-100, FSO, FS-300 and UR (all trade names, manufactured by DuPont Company); FT-110, FT-250, FT-251, FT-400S, FT-150 and FT-400SW (all trade names, manufactured by Neos Corp.); and PF-151N (trade name, manufactured by Omnova Solutions, Inc.). Among these, ZONYL FS-300, FSN, FSN-100 and FSO (all trade names, manufactured by Dupont Company) are particularly preferred from the viewpoint that these products are satisfactory in terms of the enhancement of reliability and color developability.

The amount of addition of the fluorine-based surfactant in the ink composition is not particularly limited. However, an amount of addition which results in a surface tension in the below-described range is preferable. The amount of addition is preferably 0.01 to 7.0% by mass, more preferably 0.1 to 5.0% by mass, and even more preferably 0.3 to 3.0% by mass.

Water

The ink composition according to the invention contains water. An amount of water is not particularly limited. The amount of water is preferably from 10% by mass to 99% by mass, more preferably from 30% by mass to 80% by mass, and even more preferably from 50% by mass to 70% by mass, relative to a total mass of the ink composition, from the viewpoint of securing stability and ejection reliability.

Water-Soluble Organic Solvent

The ink composition of the invention preferably contains at least one water-soluble organic solvent.

The water-soluble organic solvent may be used for drying prevention, wetting or penetration promotion. For drying prevention, the water-soluble organic solvent is used as a drying preventing agent for preventing clogging of an ink ejection opening of an ejection nozzle due to an aggregate formed of adhered and dried inks. For preventing drying and/or for wetting, water-soluble organic solvents having a low vapor pressure than that of water are preferable. For promoting penetration, the water-soluble organic solvents can be used as a penetration accelerator that increases penetration properties of inks in paper.

Examples of the water-soluble organic solvents include alkanediols (polyhydric alcohols), such as glycerol, 1,2,6-hexanetriol, trimethylolpropane, ethylene glycol, propylene glycol, diethylene glycol, triethylene glycol, tetraethylene glycol, pentaethylene glycol, dipropylene glycol, 2-butene-1,4-diol, 2-ethyl-1,3-hexanediol, 2-methyl-2,4-pentanediol, 1,2-octanediol, 1,2-hexanediol, 1,2-pentanediol, or 4-methyl-1,2-pentanediol; saccharides, such as glucose, mannose, or fructose; sugar alcohols; hyaluronic acids; alkyl alcohols having 1 to 4 carbon atoms, such as ethanol, methanol, butanol, propanol, or isopropanol; glycol ethers, such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, dipropylene glycol monomethyl ether, dipropylene glycol monoethyl ether, tripropylene glycol monomethyl ether, dipropylene glycol mono-n-propyl ether, or dipropylene glycol mono-iso-propyl ether; 2-pyrrolidone, and N-methyl-2-pyrrolidone. Only one kind of these alcohols may be used singly or two more kinds thereof may be used in combination.

For drying prevention or wetting, polyhydric alcohols are useful. Examples of the polyhydric alcohol include glycerol, ethylene glycol, diethylene glycol, triethylene glycol, propylene glycol, dipropylene glycol, tripropylene glycol, 1,3-butanediol, and 2,3-butanediol. Only one kind of these polyhydric alcohols may be used singly or two or more kinds thereof may be used in combination.

For promoting penetration, polyol compounds are preferable and aliphatic diols are suitable. Examples of the aliphatic diols include 2-ethyl-2-methyl-1,3-propanediol, 3,3-dimethyl-1,2-butanediol, 2,2-diethyl-1,3-propanediol, 2-ethyl-1,3-hexanediol, and 2,2,4-trimethyl-1,3-pentanediol. Among the above, preferable examples include 2-ethyl-1,3-hexanediol and 2,2,4-trimethyl-1,3-pentanediol.

In the ink composition of the invention, 70% by mass or more of the water-soluble organic solvents are water-soluble organic solvents having an SP value of 27.5 or lower. When the water-soluble organic solvents having an SP value of 27.5 or lower are used, the occurrence of curling under various environmental humidity after recording can be further suppressed. Moreover, the fixability may also increase due to interaction with resin particles. In particular, when the proportion of water-soluble organic solvents having a relatively low SP value are increased by adjusting the proportion of the water-soluble organic solvents having an SP value of 27.5 or lower to be 70% by mass or more of the whole water-soluble organic solvents, the scratch resistance of images can be increased and offset can be effectively suppressed.

The solubility parameter (SP value) of a water-soluble solvent as used in the invention is a value expressed by the square root of cohesive energy of molecules. SP values can be calculated by the method described in R. F. Fedors, Polymer Engineering Science, 14, pp. 147 to 154 (1974).

In order to prevent clogging at a nozzle opening of a head due to drying of ink jet ink compositions at the nozzle head, the solvents can be used for preventing drying or wetting. For drying prevention or wetting, water-soluble organic solvents having a lower vapor pressure than that of water are preferable. In order to more sufficiently penetrate the ink composition in paper, the water-soluble organic solvents are preferably used for promoting the penetration.

Preferable examples of the water-soluble organic solvents having an SP value of 27.5 or lower include the following compounds.

Diethylene glycol monoethyl ether (SP value: 22.4)

Diethylene glycol monobutyl ether (SP value: 21.5)

Triethylene glycol monomethyl ether (SP value: 22.1)

Triethylene glycol monoethyl ether (SP value: 21.7)

Triethylene glycol monobutyl ether (SP value: 21.1)

Dipropylene glycol monomethyl ether (SP value: 21.3)

Dipropylene glycol (SP value: 27.2)

Tripropylene glycol monomethyl ether (20.4)

Alkylene oxide adduct of glycerol represented by the following Formula (1)

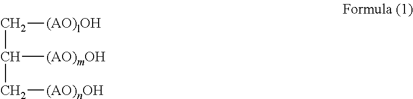

In Formula (1), l, m, and n each independently represent an integer of 1 or more, and the sum of l, m and n (I+m+n) is from 3 to 15. When the value of l+m+n is 3 or more, the effect of suppressing curling may be favorable. When the value of l+m+n is 15 or lower, favorable ejection properties may be maintained. In particular, the value of l+m+n is preferably in the range of from 3 to 12 and more preferably in the range of from 3 to 10. AO in Formula (1) represents ethyleneoxy (which may sometimes be abbreviated as EO) and/or propyleneoxy (which may sometimes be abbreviated as PO). In particular, a propyleneoxy group is preferable. Each AO of (AO)ₗ, (AO)ₘ, and (AO)ₙ may be the same or different.

Examples of the compound represented by Formula (1) are shown below. The value in the brackets is an SP value. The present invention is not limited to these compounds.

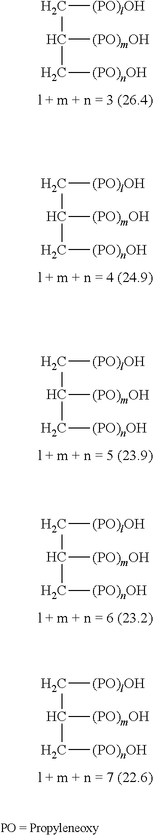

nC₄H₉O(AO)₄—H

(AO=EO or PO (EO:PO=1:1), SP value=20.1)

nC₄H₉O(AO)₁₀—H

(AO=EO or PO (EO:PO=1:1), SP value=18.8)

HO(A′O)₄₀—H

(A′O=EO or PO (EO:PO=1:3), SP value=18.7)

HO(A″O)₅₅—H

(A″0=EO or PO (EO:PO=5:6), SP value=18.8)

HO(PO)₃—H(SP value=24.7)

HO(PO)₇—H(SP value=21.2)

1,2-hexanediol (SP value=27.4)

EO represents an ethylene oxy group and PO represents a propyleneoxy group.

As the alkylene oxide adduct of glycerol, any of commercially available products currently marketed may be used. Examples of the commercial available alkylene oxide adduct of glycerol include, as polyoxypropylated glycerol (ether of polypropylene glycol and glycerol), SANNIX GP-250 (average molecular weight: 250), SANNIX GP-400 (average molecular weight: 400), and SANNIX GP-600 (average molecular weight: 600) (trade names, manufactured by Sanyo Chemical Industries, Ltd.), LEOCON GP-250 (average molecular weight: 250), LEOCON GP-300 (average molecular weight: 300), LEOCON GP-400 (average molecular weight: 400), LEOCON GP-700 (average molecular weight: 700) (trade names, manufactured by LION Corporation), and polypropylenetriol glycol.triol types (average molecular weight: 300; and average molecular weight: 700) (manufactured by Wako Pure Chemical Ind., Ltd.).

One kind of the water-soluble organic solvent can be used singly or two or more kinds may be used a mixture. The combination for the mixture is not particularly limited. When an alkylene oxide adduct of glycerol represented by Formula (1) and an alkylene glycol alkyl ether having an SP value of 23 or lower (preferably SP value of 22 or lower) (preferably di- or tri-alkylene glycol monoalkyl ether (the number of carbon atoms of the alkyl portion is preferably 1 to 4) are combined, the fixability further may increase and blocking of images can be effectively suppressed. In this case, a mixing ratio (a:b) of the alkylene oxide adduct of glycerol (a) represented by Formula (1) and the alkylene glycol alkyl ether having an SP value of 23 or lower (b) is preferably in the range of 1:5 to 5:1 and more preferably in the range of 1:2.5 to 2.5:1 based on the reasons as described above.

The ink composition preferably contains the water-soluble organic solvents in a proportion of lower than 20% by mass relative to the total mass of the composition. When high speed recording is performed using, for example, a single pass method, a content of the water-soluble organic solvents of lower than 20% by mass may be advantageous for performing treatment, such as drying, fixing, or the like after recording, in a short time and the occurrence of blocking and offset can be effectively suppressed.

In particular, the content of the water-soluble organic solvents is preferably 5% by mass or more and lower than 20% by mass and more preferably from 7% by mass to 17% by mass relative to the total mass of the composition.

Other Components

The ink composition may further contain various additives as other components according to necessity, in addition to the components described above.

Examples of the various additives include those known additives such as an ultraviolet absorbent, a fading preventing agent, an anti-mold agent, a pH adjusting agent, an anti-rust agent, an antioxidant, an emulsion stabilizer, a preservative, an antifoaming agent, a viscosity adjusting agent, a dispersion stabilizer, a chelating agent, a drying preventing agent (wetting agent), a penetration accelerating agent, a surface tension adjuster, and a dispersant.

Solid components that are solid in ink composition at 25° C.

In the ink composition according to the invention, a total content in the ink composition of solid components that are solid in the ink composition at 25° C. is preferably from 2.0% by mass to less than 20% by mass relative to a total mass of the ink composition. The total content is more preferably from 5% by mass to less than 18% by mass, and even more preferably from 10% by mass to less than 15% by mass.

When the total content of the solid components in the ink composition is less than 20% by mass, since the amount of incorporation of liquid components that are effective for preventing the clogging of nozzles may be decreased, beading is difficult to occur, and the drying speed may be further enhanced. Furthermore, when the amount of incorporation of the liquid components becomes smaller, the amount of the liquid components that remain near the surface of the recording medium in the image areas after recording becomes smaller than before, and thus drying occurs more rapidly. Then, the liquid components do not obstruct binding between the solid components (pigment and the resin as a fixing agent) and binding between the solid components and the recording medium, and fixability may be enhanced.

On the other hand, when the total content of the solid components in the ink composition is 2.0% by mass or greater, the amount of liquid components (including water) in the ink is decreased, and thus the amount of liquid components that are absorbed into the recording medium is also decreased, thereby drying being accelerated. At the same time, corrugation (cockling) does not easily occur on the recording medium.

Examples of the solid components that are solid in the ink composition at 25° C. include a pigment, a pigment dispersant and resin particles. The details of these components are as described in the above.

Here, the term solid in the ink composition at 25° C. means that a component is solid in an ink at normal temperature and normal pressure (25° C. and 1 atmosphere) which are typical environments for use in the inkjet recording.

Liquid Components that are Liquid in Ink Composition at 25° C. and have Higher Boiling Points than Water

The ink composition according to the invention contains liquid components that are liquid in the ink composition at 25° C. and have lower vapor pressures than that of water. It is preferable that the ratio of the total content (A) of the liquid components in the ink composition and the total content (B) of the solid components in the ink composition (A/B), be 0.70 to 1.75.

The liquid components that are liquid in the ink composition at 25° C. and have higher boiling points than water, are mostly water-soluble organic solvents having high boiling points, and those ink property controlling agents such as a surfactant are also included in the liquid components, as long as the agents are liquid in the ink composition at 25° C. and have higher boiling points than that of water.

In the ink composition of the present invention, a ratio of a total content (A) of the liquid components in the ink composition and a total content (B) of the solid components in the ink composition (A/B) is preferably 0.70 to 1.75. The ratio is more preferably 1.00 to 1.70, and even more preferably 1.20 to 1.65.

When the ratio (A/B) is from 0.70 to 1.75, there are provided an inkjet recording apparatus and an image forming method, in which even if printing is performed on a coated paper for printing having a small liquid absorption capacity, beading hardly occurs, the drying speed is satisfactory, sharp images that are close to offset-printed matters are obtained, and clogging of nozzles does not occur even during a long-term rest. Particularly, when the ratio (A/B) is 0.70 or greater, clogging of nozzles hardly occurs even during a long-term rest, and when the ratio is 1.75 or less, drying of recorded images occurs more rapidly.

—Properties of Ink Composition—

The ink composition according to the invention has a surface tension at 25° C. of from 17 mN/m to 40 mN/m. When the surface tension is 20 mN/m or greater, formation of ink droplets (particularization) is satisfactorily achieved, and stable ejection of ink may be achieved, so that permeation of the ink into the recording medium may be suppressed. Furthermore, when the surface tension is 40 mN/m or less, ink penetration into the recording medium is satisfactorily achieved, and the drying time may be shortened.

The surface tension is preferably 20 mN/m to 35 mN/m, and more preferably 23 mN/m to 30 mN/m, from the viewpoint of achieving the stable ejection of ink droplets and the resolution property of the printed images in combination.

Here, the surface tension of the ink composition is measured under the conditions of 25° C. using an Automatic Surface Tensiometer (trade name: CBVP-Z, manufactured by Kyowa Interface Science Co., Ltd.). The surface tension of the ink composition may be adjusted by regulating the amount of addition of the surfactant as a surface tension adjusting agent as described above.

Furthermore, the viscosity of the ink composition at 25° C. is preferably from 1.2 mPa·s to 15.0 mPa·s, more preferably from 2 mPa·s to less than 13 mPa·s, and even more preferably from 2.5 mPa·s to less than 10 mPa·s. The viscosity of the ink is measured under the conditions of 25° C. using a viscometer (trade name: TV-22, manufactured by Toki Sangyo Co., Ltd.).

Next, the treatment liquid applying step is described.

Treatment Liquid Applying Step

The image forming method of the invention includes a treating liquid applying step in which a treatment liquid containing at least one aggregating agent that is capable of aggregating components of an ink composition when brought into contact with the ink composition, is applied onto a recording medium, from the viewpoint of enhancing the anti-blocking properties, rubbing resistance and offset resistance of images.

When the image forming method of the invention is employed for the constitution of recording images using the ink composition described above in the presence of the treatment liquid, there are obtained effects of suppressing occurrence of curling and cockling after recording and occurrence of ink cissing, and recording of images having satisfactory anti-blocking properties, offset resistance and rubbing resistance may be achieved.

Treatment Liquid

The treatment liquid contains at least one aggregating agent. The aggregating agent produces aggregates when brought into contact with the ink composition, and any substance capable of aggregating components of the ink composition may be selected without any particular limitation.

The aggregating agent according to the invention is preferably at least one selected from the group consisting of a polyvalent metal salt, an acidic substance and a cationic polymer, from the viewpoint of the aggregatability of the ink composition, and from the viewpoint of the rate of the aggregation reaction and high resolution, the aggregating agent is more preferably an acidic substance, and even more preferably a divalent or higher-valent acidic substance.

Here, the aggregation of the ink composition is achieved by, for example, decreasing the dispersion stability of the particles dispersed in the ink composition (for example, the colorant such as a pigment, and resin particles) and increasing the viscosity of the ink composition.

Specifically, for example, when an acidic substance is used as the aggregating agent, the dispersion stability of particles such as the pigment particles and resin particles in the ink composition which has been dispersion stabilized by a weakly acidic functional group such as a carboxyl group, may be decreased by reducing the surface charge of the particles, by bringing the particles into contact with an acidic substance having a lower pKa value. Accordingly, the acidic substance as the aggregating agent contained in the treatment liquid is preferably a substance having a low pKa value and high solubility with respect to water and having a valency of 2 or more, and is more preferably a divalent or trivalent acidic substance having a high buffering capacity in a pH region lower than the pKa of the functional group (for example, a carboxyl group) that is involved in the dispersion stabilization of the particles in the ink composition.

Suitable examples of the acidic substance include phosphoric acid, phosphonic acid, phosphinic acid, sulfuric acid, sulfonic acid, sulfonic acid, carboxylic acid, coumaric acid, nicotinic acid, oxalic acid, malonic acid, succinic acid, citric acid, phthalic acid, derivatives of these compounds, and salts of these compounds or derivatives. Among them, phosphoric acid, carboxylic acid, derivatives of these compounds, and salts of these compounds or derivatives are preferred, and an acidic substance having a carboxylic acid is more preferred.

A suitable compound having a carboxyl group may be a compound having a furan, pyrrole, pyrroline, pyrrolidone, pyrone, pyrrole, thiophene, indole, pyridine or quinoline structure and further having a carboxyl group as a functional group.

Examples of such a compound having a carboxyl group include pyrrolidone carboxylic acid, pyrone carboxylic acid, pyrrole carboxylic acid, furan carboxylic acid, pyridine carboxylic acid, and thiophene carboxylic acid.

Other acidic substances having pKa and solubility values similar to these compounds may also be used.

Among the acidic substances, since citric acid has high water-retaining power and tends to increase the physical strength of the aggregated ink composition, citric acid is used with preference in the case where mechanical characteristics are more strongly demanded.

Malonic acid has low water-retaining power, and therefore, is used with preference in the case where drying of the treatment liquid needs to be accelerated.

As such, the aggregating agent may be appropriately selected and used based on secondary factors that are irrelevant to the ink composition aggregating ability.

The acidic substance may be used singly, or two or more kinds may be used in combination.

When the treatment liquid in the invention contains the acidic substances, the pH (25° C.) of the treatment liquid is preferably from 0.1 to 6.0, more preferably from 0.5 to 5.0, and still more preferably from 0.8 to 4.0.

Examples of the polyvalent metal salt include salts of any of alkaline earth metals belonging to Group II of the periodic table (e.g., magnesium and calcium), transition metals belonging to Group III of the periodic table (e.g., lanthanum), cations from Group XIII of the periodic table (e.g., aluminum), and lanthanides (e.g., neodymium). As salts of the metals, carboxylic acid salt (formate, acetate, benzoate, etc.), nitrate, chlorides, and thiocyanate are preferable. In particular, calcium salts or magnesium salts of carboxylic acids (e.g., formate, acetate, and benzoate), calcium salts or magnesium salts of nitric acid, calcium chloride, magnesium chloride, and calcium salts or magnesium salts of thiocyanic acid are preferable.

When the polyvalent metal salt is used, water resistance of the image is improved.

Examples of the cationic polymer include compounds selected from poly(vinylpyrridine) salts, polyalkylaminoethyl acrylate, polyalkylaminoethyl methacrylate, poly(vinylimidazole), polyethyleneimine, polybiguanide and polyguanide, as well as combinations thereof. Among them, polyguanide and polyethyleneimine have higher ink aggregating effects, and are preferable from the viewpoint of the image resolution property.

Furthermore, when a cationic polymer is used, satisfactory adhesiveness between the image and the recording medium is obtained.

One kind of aggregating agent may be used singly or two or more kinds of aggregating agents may be used in combination.

When the aggregating agent(s) for aggregating components of the ink composition is an acidic substance or a polyvalent metal salt, a content of the aggregating agent(s) in the treatment liquid is preferably from 1 to 50% by mass, more preferably from 5 to 40% by mass, and even more preferably from 10 to 30% by mass. When the aggregating agent(s) is a cationic polymer, a content of the cationic polymer in the treatment liquid is preferably from 0.1 to 25% by mass, more preferably from 0.5 to 20% by mass, and even more preferably from 1.0 to 15% by mass.

The treatment liquid according to the invention may generally contain a water-soluble organic solvent in addition to the aggregating agent, and may be constituted so as to further include various other additives.

The water-soluble organic solvent may be the same water-soluble organic solvents mentioned for the ink composition. The various other additives may include a surfactant and other additives. Examples of the surfactant include, in addition to the fluorine-based surfactant mentioned above for the ink composition, an anionic surfactant, a cationic surfactant, an amphoteric surfactant, a nonionic surfactant, and a betaine-based surfactant. The other additives may be the same agents as the various additives mentioned as the other components for the ink composition.

The surface tension (25° C.) of the treatment liquid is preferably from 20 mN/m to 60 mN/m or less. More preferably, the surface tension is from 25 mN/m to 50 mN/m, and even more preferably from 25 mN/m to 45 mN/m s.

The surface tension of the treatment liquid is measured under the conditions of a temperature of 25° C. using an automatic surface tensiometer (model name: CBVP-Z, manufactured by Kyowa Interface Science Co., Ltd.).

The viscosity (20° C.) of the treating liquid is preferably from 1.2 mPa·s to 15.0 mPa·s, more preferably from 2 mPa·s to less than 12 mPa·s, an even more preferably from 2 mPa·s to less than 8 mPa·s, from the viewpoint of application stability. When the viscosity is adjusted to the range mentioned above, in the case of carrying out the application of the treating liquid by a coating method, the treating liquid may be applied more uniformly and stably. The viscosity of the treating liquid is measured using a viscometer (trade name: TV-22, manufactured by Toki Snagyo Co., Ltd.).

The viscosity of the treating liquid may be appropriately modified by a conventionally implemented method such as adjustment of the type or content of the water-soluble organic solvent, or addition of a viscosity adjusting agent.

In regard to the supplying of the treatment liquid on coated paper, known liquid, supplying methods may be used without any particular limitation, and any method may be selected. Examples of the method include spray coating, coating with a coating roller, supplying by an ink-jet method, and dipping.

Specific examples of a liquid supplying method include size press methods represented by a horizontal size press method, a roll coater method, a calender size press method or the like; size press methods represented by an air knife coater method or the like; knife coater methods represented by an air knife coater method; roll coater methods represented by a transfer roll coater method such as a gate roll coater method, a direct roll coater method, a reverse roll coater method, a squeeze roll coater method or the like; blade coater methods represented by a billblade coater method, a short dwell coater method, a two stream coater method; bar coater methods represented by a rod bar coater method; bar coater methods represented by a rod bar coater method; cast coater methods; gravure coater method; curtain coater methods; die coater methods; brush coater methods; and transfer methods.

Furthermore, a method of coating in which the coating amount is controlled using a coating apparatus equipped with a liquid amount controlling member, as in the case of the coating apparatus described in JP-A No. 10-230201, may be used.

The treatment liquid may be supplied over the entire surface of the recording medium (coated paper). Alternatively, the treatment liquid may be supplied to a region where ink-jet recording is performed in the subsequent image recording step. According to the invention, in view of uniformly adjusting the amount of supplying of the treatment liquid, uniformly recording fine lines, fine image portions or the like, and suppressing image unevenness such as density unevenness, it is preferable that the treatment liquid is supplied over the entire surface of the coated paper by coating the liquid using a coating roller or the like.

As for the method of coating the treatment liquid while controlling the amount of supply of the aggregating agent to the above-described range, for example, a method of using an anilox roller may be suitably mentioned. The anilox roller is a roller in which the roller surface, being thermal spray coated with ceramics, is processed with laser and provided with a pattern of a pyramidal shape, a slant-lined shape, a hexagonal shape or the like on the surface. The treatment liquid goes into the depression areas provided on this roller surface, and when the roller surface contacts the paper surface, transfer occurs, and the treatment liquid is coated in an amount that is controlled at the depressions of the anilox roller.

The image forming method of the invention preferably further includes at least a heating step of heating the image recorded by the ink applying step and the treatment liquid applying step.

The heating step is described below.

Heating Step

The heating step fixes the image recorded by the ink applying step and the treatment liquid applying step, by heating.

The heating step according to the invention may be a drying step in which drying of the image is carried out while a heat source and the recording medium is not in contact, or may be a fixing step in which fixing of the image is carried out while a heat source and the recording medium are in contact. The heating step may also be carried out in both steps.

Drying Step

The drying step removes by drying at least a portion of the solvent in the ink composition applied on the recording medium. In the drying step according to the invention, the treatment is carried out while the heat source and the recording medium are not in contact. The method of the treatment is not particularly limited, and specifically, the treatment may be carried out by applying a generally used method, such as air blowing from a heat source against the image area (supply of dry air).

If both the drying step and the fixing step are carried out in the invention, it is preferable to carry out the drying step prior to the fixing step, from the viewpoint of effectively preventing the offset phenomenon.

Fixing Step

In the fixing step, immobilization (fixing treatment) of an image is carried out by pressing and heating an image area with a pressing member that combines a pressure applying unit that applies pressure to the image area and a heating unit that heats the image area. Examples of the pressure applying unit include a pair of rolls pressing each other, and a pressing plate, and examples of the heating unit include a heating roll and a hot plate. Specifically, a treatment of pressing the surface of the recording medium with a heating roll, a hot plate or the like may be carried out.

The fixing temperature in the fixing step is preferably below 100° C. The fixing temperature is more preferably from 50° C. to less than 90° C., and further more preferably from 60° C. to less than 80° C. If the fixing temperature is too low, fixing is insufficiently achieved, and rubbing resistance may be deteriorated. If the fixing temperature is too high, the latex may be softened, and the fixing offset may be worsened.

The fixing temperature according to the invention refers to the temperature of the area in the pressing member that is contacted under pressure with the recording medium.

The pressure at the time of pressing is preferably adjusted in the range of from 0.1 to 3.0 MPa, more preferably from 0.1 to 1.0 MPa, and even more preferably from 0.1 to 0.5 MPa, from the viewpoint of surface smoothening.

As such, the image forming method of the invention includes at least the ink applying step and the treatment liquid applying step, and if necessary, may be constituted to further include other steps such as a heating step.

Drying and Removing Step

According to the invention, it is preferable to carry out a drying and removing step in which, after the treatment liquid has been applied by the treatment liquid step, the solvent contained in the treatment liquid is removed by drying. When the solvent in the treatment liquid is removed by drying after the application of the treatment liquid, occurrence of curling or cockling or occurrence of cissing may be suppressed more effectively, rubbing resistance of recorded images may be further enhanced, and recording of images may be carried out more satisfactorily.

The drying and removing step is not particularly limited as long as at least a portion of the solvent (for example, water or a water-soluble organic solvent) contained in the treating liquid may be removed. The removal by drying of the solvent may be carried out by a method of drying by, for example, heating or air blowing (blowing dry air, or the like).

Exemplary embodiments of the invention will be listed below.

<1> An image forming method including at least an ink applying step of applying, by an inkjet method, an ink composition containing at least one pigment as a coloring material, at least one kind of resin particles, at least one fluorine-based surfactant and water, onto a recording medium having a single pigment layer or multiple pigment layers provided on or above at least one surface of a support containing a cellulose pulp as a main component, and showing an amount of transfer of purified water to a medium, when measured with a dynamic scanning absorptometer, of from 1 ml/m² to 15 ml/m² for a contact time of 100 ms, and of from 2 ml/m² to 20 ml/m² for a contact time of 400 ms; and a treatment liquid applying step of applying a treatment liquid containing at least one aggregating agent that aggregates components in the ink composition.

<2> The image forming method as set forth in the item <1>, wherein the recording medium is a coated paper, a lightweight coated paper or a lightly coated paper.

<3> The image forming method as set forth in the item <1> or <2>, wherein the aggregating agent is at least one selected from the group consisting of a polyvalent metal salt, an acidic substance and a cationic polymer.

<4> The image forming method as set forth in the item <3>, wherein the aggregating agent is an acidic substance having a carboxyl group.

<5> The image forming method as set forth in any one of the items <1> to <4>, wherein the ink composition contains solid components that are solid in the ink composition at 25° C., and liquid components that are liquid in the ink composition at 25° C. and have lower vapor pressure than water; a total content of the solid components in the ink composition is from 2.0% by mass to less than 20% by mass relative to the total mass of the ink composition; and a ratio (AB) of a total content (A) of the liquid components in the ink composition and a total content (B) of the solid components in the ink composition is 0.70 to 1.75.

<6> The image forming method as set forth in the item <5>, wherein a proportion of the resin particles in the total content (B) of the solid components in the ink composition is 40% by mass or greater.

<7> The image forming method as set forth in the item <5> or <6>, wherein the total content (B) of the solid components in the ink composition is from 10% by mass to less than 20% by mass relative to a total mass of the ink composition.

<8> The image forming method as set forth in any one of the items <1> to <7>, wherein the resin particles are self-dispersing polymer particles.

<9> The image forming method as set forth in any one of the items <1> to <8>, further including at least a heating step of heating the image recorded by the ink applying step and the treatment liquid applying step.

<10> The image forming method as set forth in the item <9>, wherein the heating step is at least one of a drying step of performing drying of the image under the condition that a heat source and the recording medium are not in contact or a fixing step of performing fixing of the image under the condition that a heat source and the recording medium are in contact.

<11> The image forming method as set forth in the item <10>, wherein a fixing temperature in the fixing step is less than 100° C.

<12> The image forming method as set forth in any one of the items <1> to <11>, wherein a glass transition temperature of the resin particles is 80° C. or more.

According to the invention, it is possible to provide an image forming method which is capable of high-definition full-color printing on commercial printing paper, and capable of forming images showing high resolution and excellent image uniformity.

### EXAMPLES

Hereinafter, the invention is described in more detail with reference to Examples. However, the invention is not limited to the following Examples insofar as the gist thereof is not exceeded. Unless otherwise specified, all of “part (s)” and “%” are based on mass.

### Production Example 1

### Preparation of Polymer Solution A

A 1-L flask equipped with a mechanical stirrer, a thermometer, a nitrogen gas inlet tube, a reflux tube and a dropping funnel was sufficiently purged with nitrogen gas, and then 11.2 g of styrene, 2.8 g of acrylic acid, 12.0 g of lauryl methacrylate, 4.0 g of polyethylene glycol methacrylate, 4.0 g of a styrene macromer (trade name: AS-6, manufactured by Toagosei Co., Ltd.), and 0.4 g of mercaptoethanol were mixed therein. The temperature of the mixture was raised to 65° C.

Next, a mixed solution of 100.8 g of styrene, 25.2 g of acrylic acid, 108.0 g of lauryl methacrylate, 36.0 g of polyethylene glycol methacrylate, 60.0 g of hydroxylethyl methacrylate, 36.0 g of styrene macromer (trade name: AS-6, manufactured by Toagosei Co., Ltd.), 3.6 g of mercaptoethanol, 2.4 g of azobismethylvaleronitrile, and 18 g of methyl ethyl ketone, was added dropwise into the flask over 2.5 hours. After completion of the dropwise addition, a mixed solution of 0.8 g of azobismethylvaleronitrile and 18 g of methyl ethyl ketone was added dropwise into the flask over 0.5 hours. The mixture was aged for one hour at 65° C., subsequently 0.8 g of azobismethylvaleronitrile was added thereto, and the mixture was further aged for one hour. After completion of the reaction, 364 g of methyl ethyl ketone was added to the flask, and thus 800 g of a polymer solution A having a concentration of 50% by mass was prepared.

### Production Example 1-1

### Preparation of Cyan Pigment Dispersion C-1

Next, 46 g of the obtained polymer solution A, 33 g of Pigment Blue 15:3 (trade name: PHTHALOCYANINE BLUE A220, manufactured by Dainichiseika Color & Chemicals Mfg. Co., Ltd.), 13.6 g of a 1 mol/L aqueous solution of potassium hydroxide, 20 g of methyl ethyl ketone, and 13.6 g of ion-exchanged water were sufficiently stirred, and then the mixture was kneaded using a roll mill. The obtained paste was introduced into 200 g of purified water, and the mixture was sufficiently stirred. Then, methyl ethyl ketone and water were distilled off using an evaporator, and then glycerin was added thereto. Thus, a cyan pigment dispersion C-1 containing 10.9% by mass of the pigment, 7.5% by mass of the resin (solids content 18.4% by mass), and 9.1% by mass of glycerin, was prepared.

### Production Example 1-2

### Preparation of Magenta Pigment Dispersion M-1

An aqueous dispersion of magenta pigment polymer microparticles was prepared in the same manner as in the Preparation Example 1-1, except that Chromophthal Jet Magenta DMQ (Pigment Red 122; trade name, manufactured by Ciba Specialty Chemicals, Inc.) was used instead of the Pigment Blue 15:3 used in the Preparation Example 1-1. This magenta pigment dispersion M-1 contained 13.6% by mass of the pigment, 4.5% by mass of the resin (solids content 18.1% by mass), and 9.1% by mass of glycerin.

### Production Example 1-3

### Preparation of Yellow Pigment Dispersion Y-1

An aqueous dispersion of yellow pigment polymer microparticles was prepared in the same manner as in the Preparation Example 1-1, except that IRGALITE YELLOW GS (Pigment Yellow 74; trade name, manufactured by Ciba Specialty Chemicals, Inc.) was used instead of the Pigment Blue 15:3 used in the Preparation Example 1-1. This yellow pigment dispersion Y-1 contained 10.9% by mass of the pigment, 7.5% by mass of the resin (solids content 18.4% by mass), and 9.1% by mass of glycerin.

### Production Example 2

### Preparation of Black Pigment Dispersion K-1

90 g of a carbon black having a CTAB specific surface area of 150 m²/g and a DBP oil absorption of 100 ml/100 g, was added to 3000 ml of a 2.5 N sodium sulfate solution, and the mixture was allowed to react for 10 hours at a temperature of 60° C., while the mixture was stirred at a rate of 300 rpm, thereby carrying out an oxidation treatment. This reaction liquid was filtered, the carbon black separated by filtration was neutralized with a sodium hydroxide solution, and ultrafiltration was carried out. The obtained carbon black was washed with water, dried, and dispersed in purified water so as to obtain a pigment concentration of 20% by mass (solids content 20% by mass). Thus, a black pigment dispersion K-1 was prepared.

### Production Example 3

### Preparation of Aqueous Dispersion of Resin Particles A

A 1-L flask equipped with a mechanical stirrer, a thermometer, a nitrogen gas inlet tube, a reflux tube and a dropping funnel was sufficiently purged with nitrogen gas, and then 8.0 g of LATEMUL S-180 (reactive emulsifier having unsaturated carbon; trade name, manufactured by Kao Corp., component 100% by mass) and 350 g of ion-exchanged water were added thereto and mixed. The temperature of the mixture was raised to 65° C. After raising the temperature, 3.0 g of t-butyl peroxobenzoate, which is a reaction initiator, and 1.0 g of sodium isoascorbate were added thereto, and after 5 minutes, a mixture of 45 g of methyl methacrylate, 160 g of 2-ethylhexyl methacrylate, 5 g of acrylic acid, 45 g of butyl methacrylate, 30 g of cyclohexyl methacrylate, 15 g of vinyltriethoxysilane, 8.0 g of LATEMUL S-180 (reactive emulsifier having unsaturated carbon; trade name, manufactured by Kao Corp., component 100% by mass), and 340 g of ion-exchanged water, was added dropwise over 3 hours. Subsequently, the mixture was aged by heating at 80° C. for 2 hours, and then was cooled to room temperature. The pH of the mixture was adjusted to a range of from 7 to 8 with sodium hydroxide. Ethanol was distilled off using an evaporator, the water content was adjusted, and thereby 730 g of an aqueous dispersion of resin particles A having a solids content of 40% by mass was prepared.

### Production Example 4-1

### Production of Resin Particles

Synthesis of Self-Dispersing Polymer B-1

In a 2 L three necked flask having a mechanical stirrer, a thermometer, a reflux condenser tube, and a nitrogen gas introducing pipe, 540.0 g of methyl ethyl ketone was charged, and the temperature was increased to 75° C. While maintaining the temperature in the reactor at 75° C., a mixed solution containing 108 g of methyl methacrylate, 388.8 g of isobornyl methacrylate, 43.2 g of methacrylic acid, 108 g of methyl ethyl ketone, and 2.16 g of “V-601” (trade name, manufactured by Wako Pure Chemical Inc., Ltd.) was added dropwise to the reactor at a constant speed so that the dropwise addition was completed in 2 hours. After the completion of the dropwise addition, a solution containing 1.08 g of “V-601” and 15.0 g of methyl ethyl ketone was added, and the resulting mixture was stirred at 75° C. for 2 hours. Thereafter, a solution containing 0.54 g of “V-601” and 15.0 g of methyl ethyl ketone were further added, and the resulting mixture was stirred at 75° C. for 2 hours. Thereafter, the temperature was increased to 85° C., and the mixture was continuously stirred for further 2 hours, thereby obtaining a resin solution of methyl methacrylate/isobornyl methacrylate/methacrylic acid (=20/72/8 [mass ratio]) copolymer.

The weight average molecular weight (Mw) of the obtained copolymer was 61,000 and the acid value thereof was 52.1 mgKOH/g.

The weight average molecular weight was measured by gel permeation chromatography (GPC) and calculated in terms of polystyrene. In GPC, HLC-8020GPC (trade name, manufactured by Tosoh Corporation) was used, and 3 pieces of columns of TSK gel Super HZM-H, TSK gel Super HZ4000 and TSK gel Super HZ200 (all trade names, manufactured by Tosoh Corporation) were used, and THF (tetrahydrofuran) was used as an eluate. The acid value was measured according to the method described in JIS standard (JIS K0070:1992).

Next, 588.2 g of the resin solution was weighed, 165 g of isopropanol and 120.8 ml of 1 mol/L aqueous NaOH solution were added, and the temperature inside the reactor was increased to 80° C. Next, 718 g of distilled water was added dropwise at a rate of 20 ml/min to form water dispersion. Thereafter, the content in the reactor was held under atmospheric pressure while maintaining the temperature inside the reactor at 80° C. for 2 hours, at 85° C. for 2 hours, and then at 90° C. for 2 hours, and the solvent was distilled off. Further, the pressure in the reactor was reduced, and isopropanol, methyl ethyl ketone, and distilled water were distilled off, thereby obtaining an aqueous dispersion of self-dispersing polymer B-1 (resin particles) having a solid content of 26.0% by mass.

### Production Examples 4-2 to 4-5

### Preparation of Aqueous Dispersions of Resin Particles B-2 to B-5

Aqueous dispersions of resin particles B-2 to B-5 were prepared in the same manner as in the Production Example 4-1, except that the type and proportions of the monomers used in the Production Example 4-1 were respectively changed as follows.
B-2: Methyl methacrylate/dicyclopentanyl methacrylate/methacrylic acid (=40/50/10)

The obtained copolymer had a weight average molecular weight (Mw) of 55,000, and an acid value of 65.1 mg KOH/g. The solids content of the aqueous dispersion was 25% by mass.
B-3: Methyl methacrylate/dicyclopentanyl methacrylate/methoxypolyethylene glycol methacrylate (n=2)/methacrylic acid (54/35/5/6)

The obtained copolymer had a weight average molecular weight (Mw) of 60,000, and an acid value of 39.1 mg KOH/g. The solids content of the aqueous dispersion was 25% by mass.
B-4: n-butyl methacrylate/cyclohexyl methacrylate/styrene/acrylic acid copolymer (30/55/10/5)

The obtained copolymer had a weight average molecular weight (Mw) of 58,000, and an acid value of 38.9 mg KOH/g. The solids content of the aqueous dispersion was 25% by mass.
B-5: Phenoxyethyl acrylate/methyl methacrylate/acrylic acid copolymer (20/70/10)

The obtained copolymer had a weight average molecular weight (Mw) of 63,000, and an acid value of 77.8 mg KOH/g. The solids content of the aqueous dispersion was 25% by mass.

Measured values of the glass transition temperatures (measured Tg) of the resin particles A, B-1 to B-5 are shown in the following Table 1. The measured Tg was measured by the method described below.

An aqueous dispersion of 0.5 g of resin particles as a solid component was dried under reduced pressure at 50° C. for 4 hours, thereby obtaining a polymer solid component. The obtained polymer solid component was used to measure Tg with a differential scanning calorimeter (DSC) (trade name: EXSTAR6220, manufactured by SII Nanotechnology, Inc.). The measurement conditions were such that 5 mg of a sample was sealed in an aluminum pan and was heated according to the following temperature profile in a nitrogen atmosphere. The value of the peak top of DDSC of the measured data obtained upon the second temperature raise was designated as the measured Tg.

30° C.→−50° C. (cooled at a rate of 50° C./min)

−50° C.→120° C. (heated at a rate of 20° C./min)

120° C.→−50° C. (cooled at a rate of 50° C./min)

−50° C.→120° C. (heated at a rate of 20° C./min)

TABLE 1

| | Measured Tg (° C.) |
|---|---|
| Resin particles A | −15 |
| Resin particles B-1 | 180 |
| Resin particles B-2 | 130 |
| Resin particles B-3 | 100 |
| Resin particles B-4 | 86 |
| Resin particles B-5 | 71 |

### Production Example 5

### Preparation of Inks 1 to 22

The pigment dispersions C-1, M-1, Y-1 and K-1, and the aqueous dispersions of the resin particles A and B-1 to B-5 obtained in the Production Examples were used, and cyan color inks 1 to 11, 15 and 16, magenta color inks 12 and 17, yellow color inks 13 and 18, and black color inks 14 and 19 were respectively prepared to have the compositions indicated in Table 2 shown below. Here, the surface tension, content of the solid components, content of the liquid components and the like of each ink are shown in the following Tables 2 to 4. In the tables, ZONYL FS-300 and ZONYL FSO (all trade names, manufactured by Dupont Company) are fluorine-based surfactants, and ORFIN E-1010 (trade name, manufactured by Nissin Chemical Industry Co., Ltd.) is an acetylene glycol-based surfactant.

TABLE 2

| | Ink 1 | Ink 2 | Ink 3 | Ink 4 | Ink 5 | Ink 6 | Ink 7 |
|---|---|---|---|---|---|---|---|
| Cyan pigment dispersion C-1 | 45.8% | 40.0% | 45.8% | 22.9% | 22.9% | 27.5% | 22.9% |
| Magenta pigment dispersion M-1 | | | | | | | |
| Yellow pigment dispersion Y-1 | | | | | | | |
| Black pigment dispersion K-1 | | | | | | | |
| Resin particles A | 10.0% | | | | | | |
| Resin particles B-1 | | 10.0% | 15.4% | 32.7% | 32.7% | 38.5% | |
| Resin particles B-2 | | | | | | | 32.7% |
| Resin particles B-3 | | | | | | | |
| Resin particles B-4 | | | | | | | |
| Resin particles B-5 | | | | | | | |
| Glycerin | 4.0% | 14.5% | 14.5% | 12.9% | 8.3% | 5.5% | 8.3% |
| 1,3-Butanediol | | | | | | | |
| 2-Ethyl-1,3-hexanediol | 2.0% | 2.0% | 2.0% | 2.0% | 2.0% | 2.0% | 2.0% |
| ZONYL FS-300 | 2.5% | 2.5% | 2.5% | 2.5% | 2.5% | 2.5% | 2.5% |
| ZONYL FSO | | | | | | | |
| ORFIN E-1010 | | | | | | | |
| Triethanolamine | 0.3% | 0.3% | 0.3% | 0.3% | 0.3% | 0.3% | 0.3% |
| Water | 35.4% | 30.7% | 19.5% | 26.7% | 31.3% | 23.7% | 31.3% |
| Total | 100% | 100% | 100% | 100% | 100% | 100% | 100% |
| Surface tension | 25.2 | 24.7 | 24.8 | 24.7 | 25.0 | 25.1 | 24.8 |
| Content of solid components (B) | 12.4% | 10.0% | 12.4% | 12.7% | 12.7% | 15.1% | 12.7% |
| Proportion of resin particles | 32.2% | 26.1% | 32.2% | 66.8% | 66.8% | 66.4% | 66.8% |
| in solid components | | | | | | | |
| Content of liquid components (A) | 11.1% | 21.1% | 21.7% | 18.0% | 13.3% | 11.0% | 13.3% |
| A/B | 0.90 | 2.12 | 1.74 | 1.42 | 1.05 | 0.73 | 1.05 |

TABLE 3

| | Ink 8 | Ink 9 | Ink 10 | Ink 11 | Ink 12 | Ink 13 | Ink 14 |
|---|---|---|---|---|---|---|---|
| Cyan pigment dispersion C-1 | 22.9% | 22.9% | 22.9% | 22.9% | | | |
| Magenta pigment dispersion M-1 | | | | | 45.9% | | |
| Yellow pigment dispersion Y-1 | | | | | | 27.5% | |
| Black pigment dispersion K-1 | | | | | | | 36.7% |
| Resin particles A | | | | | | | |
| Resin particles B-1 | | | | 32.7% | 26.9% | 26.9% | 19.2% |
| Resin particles B-2 | | | | | | | |
| Resin particles B-3 | 32.7% | | | | | | |
| Resin particles B-4 | | 32.7% | | | | | |
| Resin particles B-5 | | | 32.7% | | | | |
| Glycerin | 8.3% | 8.3% | 8.3% | 8.3% | 8.3% | 9.8% | 12.3% |
| 1,3-Butanediol | | | | | | | |
| 2-Ethyl-1,3-hexanediol | 2.0% | 2.0% | 2.0% | 2.0% | 2.0% | 2.0% | 2.0% |
| ZONYL FS-300 | 2.5% | 2.5% | 2.5% | | | | |
| ZONYL FSO | | | | 1.0% | 1.0% | 1.0% | 1.0% |
| ORFIN E-1010 | | | | | | | |
| Triethanolamine | 0.3% | 0.3% | 0.3% | 0.3% | 0.3% | 0.3% | 0.3% |
| Water | 31.3% | 31.3% | 31.3% | 32.8% | 15.6% | 32.5% | 28.5% |
| Total | 100% | 100% | 100% | 100% | 100% | 100% | 100% |
| Surface tension | 24.9 | 25.0 | 25.3 | 20.3 | 21.2 | 20.4 | 20.7 |
| Content of solid components (B) | 12.7% | 12.7% | 12.7% | 12.7% | 15.4% | 12.1% | 12.3% |
| Proportion of resin particles | 66.8% | 66.8% | 66.8% | 66.8% | 45.3% | 58.0% | 40.5% |
| in solid components | | | | | | | |
| Content of liquid components (A) | 13.3% | 13.3% | 13.3% | 13.1% | 15.2% | 15.0% | 15.0% |
| A/B | 1.05 | 1.05 | 1.05 | 1.03 | 0.98 | 1.24 | 1.22 |

TABLE 4

| | Ink 15 | Ink 16 | Ink 17 | Ink 18 | Ink 19 |
|---|---|---|---|---|---|
| Cyan pigment | 45.8% | 45.8% | | | |
| dispersion C-1 | | | | | |
| Magenta pigment | | | 39.1% | | |
| dispersion M-1 | | | | | |
| Yellow pigment | | | | 30.6% | |
| dispersion Y-1 | | | | | |
| Black pigment | | | | | 40.0% |
| dispersion K-l | | | | | |
| Resin particles A | | 10.0% | 16.0% | 20.0% | 13.8% |
| Resin particles B-1 | | | | | |
| Resin particles B-2 | | | | | |
| Resin particles B-3 | | | | | |
| Resin particles B-4 | | | | | |
| Resin particles B-5 | | | | | |
| Glycerin | 4.0% | 4.0% | 9.9% | 10.8% | 13.5% |
| 1,3-Butanediol | | | 4.5% | 4.5% | 4.5% |
| 2-Ethyl-1,3-hexanediol | 2.0% | 2.0% | 2.0% | 2.0% | 2.0% |
| ZONYL FS-300 | 2.5% | | | | |
| ZONYL FSO | | | | | |
| ORFIN E-1010 | | 1.0% | 1.0% | 1.0% | 1.0% |
| Triethanolamine | 0.3% | 0.3% | 0.3% | 0.3% | 0.3% |
| Water | 36.9% | 36.9% | 27.2% | 30.8% | 24.9% |
| Total | 92% | 100% | 100% | 100% | 100% |
| Surface tension | 35.4 | 35.4 | 35.2 | 34.8 | 35.5 |
| Content of solid | 8.4% | 12.4% | 13.6% | 13.6% | 13.5% |
| components (B) | | | | | |
| Proportion of resin parti- | 0.0% | 32.2% | 47.1% | 58.7% | 40.7% |
| cles in solid components | | | | | |
| Content of liquid | 11.1% | 11.1% | 21.0% | 21.2% | 21.0% |
| components (A) | | | | | |
| A/B | 1.32 | 0.90 | 1.54 | 1.55 | 1.56 |

The various components were mixed to obtain the compositions shown in the following Table 5, and thus treatment liquids A to G were prepared.

TABLE 5

| | Treatment | Treatment | Treatment | Treatment | Treatment | Treatment | Treatment |
|---|---|---|---|---|---|---|---|
| | liquid A | liquid B | liquid C | liquid D | liquid E | liquid F | liquid G |
| Malonic acid | 25% | — | — | — | — | — | — |
| Citric acid | — | 25% | — | — | — | — | — |
| Potassium nitrate tetrahydrate | — | — | 35% | — | — | — | — |
| Magnesium nitrate hexahydrate | — | — | — | 35% | — | — | — |
| Aluminum nitrate nonahydrate | — | — | — | — | 35% | — | — |
| Polyguanide | — | — | — | — | — | 10% | — |
| Polyethyleneimine | — | — | — | — | — | — | 10% |
| ORFIN E-1010 | — | — | 1% | 1% | 1% | 1% | 1% |
| Diethylene glycol monoethyl ether | 10% | 10% | — | — | — | — | — |
| Ion-exchanged water | 65% | 65% | 64% | 64% | 64% | 89% | 89% |
| Total | 100% | 100% | 100% | 100% | 100% | 100% | 100% |

Image Formation Example 1

The inks 1 to 16 obtained above were used to perform image formation under the conditions given below. Subsequently, the obtained recorded images were subjected to the following evaluations. The results are shown in the following Tables 6 and 7.

Image Formation

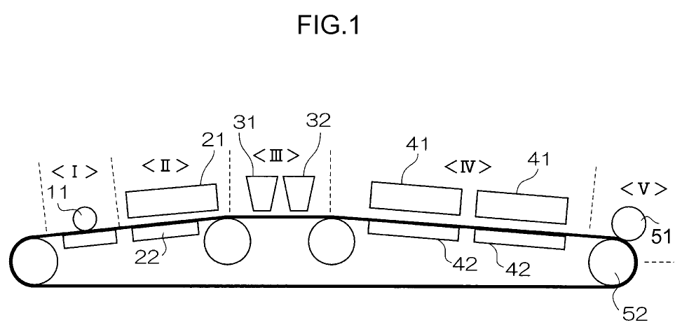

OK TOPCOAT+ (trade name, manufactured by Oji Paper Co., Ltd.; basis weight: 104.7 g/m², amount of transfer of pure water to the recording medium as measured with a dynamic scanning absorptometer: 3.0 ml/m² for a contact time of 100 ms, 3.4 ml/m² for a contact time of 400 ms) was provided as a recording medium (coated paper), and a recording apparatus having the structure shown in FIG. 1 was provided as an inkjet recording apparatus. This recording apparatus was operated, and the recording medium was fixed onto the hard rubber belt of the apparatus and was conveyed at a conveyance speed of 400 mm/sec. Thus, images were formed through the processes shown below. Reference numerals <I> to <V> in FIG. 1 respectively correspond to the process Ito process V described below.

I. Treatment Liquid Supplying Step

First, the treatment liquid A was applied over the entire surface of the recording medium using a roll coater which has an anilox roller 11 (number of lines of 100 to 300/inch) and the coating amount of which was controlled, so that the amount of supply was 1.2 g/m².

II. Treatment Step

Subsequently, the recording medium onto which treatment liquid A was applied was heated with a contact type plate heater 22 from the rear side (opposite to the recording surface) of the recording medium under the following conditions and the air was blown by a drying fan 21, thereby performing a drying treatment and penetration treatment.

Air speed: 10 m/s

Temperature: The recording medium was heated such that the surface temperature on the recorded surface side of the recording medium became 60° C.

III. Image Recording Step

Three GELJET GX5000 printer heads (trade name, full line head manufactured by Ricoh Co., Ltd.) were arranged and fixed so that the direction of the line head (main scanning direction) in which nozzles are disposed inclined at 75.7° relative to the direction orthogonal to the running direction (sub-scanning direction) of an endless hard rubber belt as illustrated in FIG. 1. In a first ink jet head 31, a second ink jet head 32 and a third ink jet head 33, the inks (Inks 1 to 6) obtained above were charged respectively. Then, the position of each of the first ink jet head, the second ink jet head and the third ink jet head was adjusted so that the ink droplets ejected from each of the heads were overlapped. Thereafter, each ink was ejected by an ink jet method under the following conditions to the coated surface of the recording medium coated with treatment liquid A, and images for evaluation were recorded with respect to each evaluation item.

Conditions

Amount of ejected ink droplet: 2.4 pL
Resolution: 1200 dpi×1200 dpi

IV. Ink Drying Step

Subsequently, the recording medium was conveyed by a belt to a dry region, and then the recording medium to which the ink droplets were applied was dried under the following conditions by blowing air with a drying fan 41 while heating with a contact type plate heater from the rear side (opposite side of the recorded surface) of the recording medium. Here, the moisture content in the recording medium on which images were recorded was determined immediately after the drying step, and the moisture content quantitatively determined by Karl Fischer coulometric titration method (trade name: CA-200, manufactured by Mitsubishi Chemical Analytech, Co., Ltd.) was from about 2.0 g/m² to about 3.0 g/m².

Conditions

Drying method: air blown drying

Air speed: 15 m/s

Temperature: The recording medium was heated so that the surface temperature on the recorded surface side of the recording medium became 60° C.

V. Fixing Step

Next, the recording medium was passed between a pair of rollers (a silicone rubber roller 51 and a large diameter drum 52) that were pressed against each other under the following conditions, thereby subjecting the images to thermal fixing treatment, and then disposed in a collection tray (not illustrated) and collected as it was. On to the surface of the silicone rubber roller 51, silicone oil was thinly applied for preventing adhesion.

Conditions

Silicone rubber roller 51: Hardness of 50°, Nip width of 5 mm

Surface temperature of silicone rubber roller: Fixing temperature each shown in Tables 6 and 7

Surface temperature of drum 52: 60° C.

Pressure: 0.2 MPa

Evaluation

Offset Resistance

A solid image formed by the inks ejected from the second ink jet head 32 was disposed on the solid image formed by the inks ejected from the first ink jet head 31. Then, a solid image formed by the inks ejected from the second ink jet head 33 was disposed on the solid image formed by the inks ejected from the first ink jet head 32, thereby forming a recorded solid image. The recorded solid image was formed by uniformly adjusting ejection rate of each ink jet head so that a total of ejection amounts from each ink jet head became 10.7 cc/m². Then, stain of each of the image surface and the silicone rubber roller was visually observed, and was evaluated in accordance with the following evaluation criteria.

Evaluation Criteria

A: No offset is observed.
B: A slight offset is observed partly. Practically non-problematic level.
C: Offset occurs. Minimum tolerable level for practical application.
D: Occurrence of offset is significant. Very low level with respect to practical application.

Image Uniformity

A solid image was formed with the ink ejected from the first inkjet head 31, and the measurement of L*a*b* values was carried out at 20 sites by changing the positions within the solid image. The color difference (SE) for the various measurement values was calculated, and the image uniformity was evaluated from the maximum values of color difference according to the following evaluation criteria.

For the measurement of L*a*b* values, SPECTROEYE (trade name, manufactured by X-Rite, Inc.) was used. The color difference (ΔE) was calculated by the following formula. When the color difference between the measured value A (L*₁, a*₁, b*ᵢ) and the measured value B (L*₂, a*₂, b*₂) is designated as ΔE,

ΔE={(L*₁−*L₂)²+(a*₁−a*₂)²+(b*₁−b*₂)²}^{1/2}

Evaluation Criteria

A: The maximum value of ΔE was less than 2, and the solid image was highly uniform.

B: The maximum value of ΔE was from 2 to less than 3, and the image uniformity was at a level practically free of problem for actual use.

C: The maximum value of ΔE was 3 or greater, and variation of hues in the image was recognized.

Image Resolution Property

Images of the Kanji character “dragon” were formed at a font size of 5 to 10 pt with the ink ejected from the first inkjet head 31, and images each including a deinked image of the Kanji character “dragon” formed at a font size of 5 to 10 pt within a solid image were formed with the ink ejected from the first inkjet head 31. The resolution properties were visually observed and evaluated according to the following evaluation criteria.

Evaluation Criteria

A: The resolution property was satisfactory even to the character of 5 pt, and the resolution property was at a level practically free of problem for actual use.

B: A decrease in the resolution property was recognized in some of the characters of 5 pt, but the resolution property was at a level practically free of problem for actual use.

C: A decrease in the resolution property was recognized even in the characters of over 5 pt, and the resolution property was at a level of low practicality.

D: The characters were deformed, and a decrease in the resolution property was conspicuous. The resolution property was at a level of low practicality.

Blocking Resistance

A solid image formed by the inks ejected from the second ink jet head 32 was disposed on the solid image formed by the inks ejected from the first ink jet head 31. Then, a solid image formed by the inks ejected from the second ink jet head 33 was disposed on the solid image formed by the inks ejected from the first ink jet head 32, thereby recording a solid image. The solid image was formed by uniformly adjusting ejection rate of each ink jet head so that a total of ejection amounts from each ink jet head became 10.7 cc/m². Immediately after recording of the solid image, an unrecorded recording medium (the same recording medium as that used for recording (hereinafter, referred to as an unused sample in regard to the current evaluation)) was placed on the solid image, and was left for 6 hours under conditions of a temperature of 45° C. and a humidity of 30% RH with a load of 350 kg/m². The degree of transfer of ink to the blank area (white background) of the unused sample was visually observed, and was evaluated according to the following evaluation criteria.

Evaluation Criteria

A: There is no transfer of ink at all.
B: Transfer of ink is hardly noticeable.
C: Some level of transfer of ink is observed. Minimum tolerable level for practical application.
D: Transfer of ink is significant.

Rubbing Resistance

A solid image formed by the inks ejected from the second ink jet head 32 was disposed on the solid image formed by the inks ejected from the first ink jet head 31. The, a solid image formed by the inks ejected from the second ink jet head 33 was disposed on the solid image formed by the inks ejected from the first ink jet head 32, thereby recording a solid image. The solid image was formed by uniformly adjusting ejection rate of each ink jet head so that a total of ejection amounts from each ink jet head became 10.7 cc/m². The recording medium to which the solid image was recorded was left to stand for 24 hours under conditions of a temperature of 25° C. and a humidity of 60% RH. Thereafter, an unrecorded recording medium (the same recording medium as that used for recording (hereinafter, referred to as an unused sample in regard to the current evaluation)) was placed on the solid image, and rubbing was performed back and forth 10 times with a load of 150 kg/m². The degree of transfer of ink to the blank area of the unused sample was visually observed, and was evaluated according to the following evaluation criteria.

Evaluation Criteria

A: There is no transfer of ink at all.
B: Transfer of ink is hardly noticeable.
C: Some level of transfer of ink is observed. Minimum tolerable level for practical
D: Transfer of ink is significant.

TABLE 6

| | Example | Example | Example | Example | Example | Example | Example | Example | Example | Example | Example |
|---|---|---|---|---|---|---|---|---|---|---|---|
| | Ink 1 | Ink 2 | Ink 2 | Ink 3 | Ink 4 | Ink 5 | Ink 6 | Ink 7 | Ink 8 | Ink 9 | Ink 10 |
| Tg of resin | −15 | 180 | 180 | 180 | 180 | 180 | 180 | 130 | 100 | 86 | 71 |
| particles (° C.) | | | | | | | | | | | |
| A/B | 0.90 | 2.12 | 2.12 | 1.74 | 1.42 | 1.05 | 0.73 | 1.05 | 1.05 | 1.05 | 1.05 |
| Treatment liquid | A | A | A | A | A | A | A | A | A | A | A |
| Fixing temper- | 140 | 140 | 80 | 80 | 80 | 80 | 80 | 80 | 80 | 80 | 80 |
| ature (° C.) | | | | | | | | | | | |
| Image resolution | A | A | A | A | A | A | A | A | A | A | A |
| property | | | | | | | | | | | |
| Image uniformity | A | A | A | A | A | A | A | A | A | A | A |
| Offset resistance | C | B | A | A | A | A | A | A | A | A | B |
| Rubbing resis- | B | A | A | A | A | A | A | A | A | A | A |
| tance | | | | | | | | | | | |
| Anti-blocking | C | A | A | A | A | A | A | A | A | A | A |
| property | | | | | | | | | | | |

TABLE 7

| | | | | | Comparative | Comparative | Comparative | Comparative |
|---|---|---|---|---|---|---|---|---|
| | Example | Example | Example | Example | Example | Example | Example | Example |
| | Ink 11 | Ink 12 | Ink 13 | Ink 14 | Ink 1 | Ink 2 | Ink 15 | Ink 16 |
| Tg of resin | 180 | 180 | 180 | 180 | −15 | 180 | — | −15 |
| particles (° C.) | | | | | | | | |
| A/B | 1.03 | 0.98 | 1.24 | 122 | 0.90 | 2.12 | 1.32 | 0.96 |
| Treatment liquid | A | A | A | A | none | none | A | A |
| Fixing temperature | 80 | 80 | 80 | 80 | 140 | 80 | 80 | 80 |
| (° C.) | | | | | | | | |
| Image resolution | A | A | A | A | C | C | B | A |
| property | | | | | | | | |
| Image uniformity | A | A | A | A | C | C | B | B |
| Offset resistance | A | A | A | A | C | C | B | C |
| Rubbing resistance | A | A | A | A | A | B | D | B |
| Anti-blocking | A | A | A | A | C | A | B | C |
| property | | | | | | | | |

As shown in the Table 6 and Table 7, images showing excellent image resolution property and image uniformity were obtained in the Examples. In regard to the offset resistance, rubbing resistance and anti-blocking property, it was found that the Examples were above the practically acceptable level.

In the Comparative Examples where images were formed only with the ink 1 or ink 2 without using a treatment liquid, it was found that the image resolution property and image uniformity were poor. It was also found that particularly in the Comparative Example 15 where images were formed with the ink 15 which did not contain resin particles, the rubbing resistance of the images was poor, and in the Comparative Example where images were formed with the ink 16 which contained a non-fluorine surfactant, the offset resistance and anti-blocking property were poor.

Image Formation Example 2

The ink 11, ink 12, ink 13 and ink 14 obtained above were grouped into ink set A, and the ink 16, ink 17, ink 18 and ink 19 were grouped into ink set H.

Images were formed in the same manner as in the Image Formation Example 1, except that the third inkjet head 33 used in the Image Formation Example 1 was not used, the ink set A or H was loaded in the first inkjet head 31 and the second inkjet head 32, and the recording medium was changed to the recording media shown in the following Table 8 and Table 9. The obtained recorded images were evaluated. The results are shown in Table 8 and Table 9. In the Table 8 and Table 9, the transfer amount (ml/m²) of pure water is the amount of transfer of pure water to the recording medium as measured with a dynamic scanning absorptometer in a contact time of 100 ms or in a contact time of 400 ms.

TABLE 8

| | | | | | | | | Ink set A | | | |
|---|---|---|---|---|---|---|---|---|---|---|---|
| | | | | Basis | Transfer amount | | | Image res- | Image | Offset | Anti- |
| | | | | weight | of purified water | | | olution | uni- | resis- | blocking |
| | | Grade | Manufacturer | (g/m²) | 100 ms | 400 ms | Treatment liquid | property | formity | tance | property |
| Exam- | OK TOPCOAT+ | A2 Gloss | Oji Paper | 104.7 | 3.0 | 3.4 | Treatment liquid A | A | A | A | A |
| ple | OK TOPCOAT+ | A2 Gloss | Oji Paper | 104.7 | 3.0 | 3.4 | Treatment liquid B | A | A | A | A |
| | OK TOPCOAT+ | A2 Gloss | Oji Paper | 104.7 | 3.0 | 3.4 | Treatment liquid C | B | A | A | A |
| | OK TOPCOAT+ | A2 Gloss | Oji Paper | 104.7 | 3.0 | 3.4 | Treatment liquid D | B | A | A | A |
| | OK TOPCOAT+ | A2 Gloss | Oji Paper | 104.7 | 3.0 | 3.4 | Treatment liquid E | B | A | A | A |
| | OK TOPCOAT+ | A2 Gloss | Oji Paper | 104.7 | 3.0 | 3.4 | Treatment liquid F | B | A | A | A |
| | OK TOPCOAT+ | A2 Gloss | Oji Paper | 104.7 | 3.0 | 3.4 | Treatment liquid G | B | A | A | A |
| | AURORA COAT | A2 Gloss | Nippon Paper | 104.7 | 2.8 | 3.4 | Treatment liquid A | A | A | A | A |
| | NEWAGE | A2 Matt | Oji Paper | 104.7 | 5.9 | 8.9 | Treatment liquid A | A | A | A | A |
| | U-LITE | A2 Matt | Nippon Paper | 104.7 | 3.9 | 5.9 | Treatment liquid A | A | A | A | A |
| | TOKUBISHI | A1 Art | Mitsubishi | 104.7 | 2.7 | 3.5 | Treatment liquid A | A | A | B | B |
| | ART BOTH- | | Paper Mills | | | | | | | | |
| | SIDED N | | | | | | | | | | |
| | OK KINFUJI+ | A1 Art | Oji Paper | 127 | 1.9 | 2.5 | Treatment liquid A | A | A | B | B |
| | SA KINFUJI+ | A1 Art | Oji Paper | 127 | 1.9 | 2.2 | Treatment liquid A | A | A | B | B |
| Comp. | MIRROR COAT | Cast- | Oji Paper | 104.7 | 0.2 | 0.3 | Treatment liquid A | C | A | D | D |
| Exam- | PLATINA | coated | | | | | | | | | |
| ple | | paper | | | | | | | | | |
| | OK TOPCOAT+ | A2 Gloss | Oji Paper | 104.7 | 3 | 3.4 | None | D | C | D | B |
| | AURORA COAT | A2 Gloss | Nippon Paper | 104.7 | 2.8 | 3.4 | None | D | C | D | B |
| | NEWAGE | A2 Matt | Oji Paper | 104.7 | 5.9 | 8.9 | None | D | C | D | B |
| | U-LITE | A2 Matt | Nippon Paper | 104.7 | 3.9 | 5.9 | None | D | C | D | B |
| | TOKUBISHI | A1 Art | Mitsubishi | 104.7 | 2.7 | 3.5 | None | D | C | D | B |
| | ART BOTH- | | Paper Mills | | | | | | | | |
| | SIDED N | | | | | | | | | | |
| | OK KINFUJI+ | A1 Art | Oji Paper | 127 | 1.9 | 2.5 | None | D | C | D | B |
| | SA KINFUJI+ | A0 Art | Oji Paper | 127 | 1.9 | 2.2 | None | D | C | D | B |

TABLE 9

| | | | | | | | | Ink set H | | | |
|---|---|---|---|---|---|---|---|---|---|---|---|
| | | | | Basis | Transfer amount | | | Image res- | Image | Offset | Anti- |
| | | | | weight | of purified water | | | olution | uni- | resis- | blocking |
| | | Grade | Manufacturer | (g/m²) | 100 ms | 400 ms | Treatment liquid | property | formity | tance | property |
| Com- | OK TOPCOAT+ | A2 Gloss | Oji Paper | 104.7 | 3.0 | 3.4 | Treatment liquid A | B | B | C | C |
| para- | AURORA COAT | A2 Gloss | Nippon Paper | 104.7 | 2.8 | 3.4 | Treatment liquid A | C | C | C | C |
| tive | NEWAGE | A2 Matt | Oji Paper | 104.7 | 5.9 | 8.9 | Treatment liquid A | C | C | C | C |
| Exam- | U-LITE | A2 Matt | Nippon Paper | 104.7 | 3.9 | 5.9 | Treatment liquid A | C | C | C | C |
| ple | TOKUBISHI | A1 Art | Mitsubishi | 104.7 | 2.7 | 3.5 | Treatment liquid A | C | C | C | C |
| | ART BOTH- | | Paper Mills | | | | | | | | |
| | SIDED N | | | | | | | | | | |
| | OK KINFUJI+ | A1 Art | Oji Paper | 127 | 1.9 | 2.5 | Treatment liquid A | C | C | C | C |
| | SA KINFUJI+ | A0 Art | Oji Paper | 127 | 1.9 | 2.2 | Treatment liquid A | C | C | C | C |
| | MIRROR COAT | Cast- | Oji Paper | 104.7 | 0.2 | 0.3 | Treatment liquid A | C | C | D | D |
| | PLATINA | coated | | | | | | | | | |
| | | paper | | | | | | | | | |

As shown in the Table 8 and Table 9, images having excellent image resolution property and image uniformity were obtained in the Examples, and in regard to the offset resistance and anti-blocking property, the Examples were practically non-problematic level.

All publications, patent applications, and technical standards mentioned in this specification are herein incorporated by reference to the same extent as if each individual publication, patent applications, or technical standards was specifically and individually indicated to be incorporated by reference.

What is claimed is:

1. An image forming method at least comprising:
applying, by an inkjet method, an ink composition comprising at least one pigment as a coloring material, at least one kind of resin particles, at least one fluorine-based surfactant and water, onto a recording medium having a single pigment layer or multiple pigment layers provided on or above at least one surface of a support comprising a cellulose pulp as a main component, and having an amount of transfer of purified water to a medium, when measured with a dynamic scanning absorptometer, of from 1 ml/m² to 15 ml/m² for a contact time of 100 ms, and of from 2 ml/m² to 20 ml/m² for a contact time of 400 ms; and
applying a treatment liquid comprising at least one aggregating agent that aggregates components in the ink composition.

2. The image forming method according to claim 1, wherein the recording medium is a coated paper, a lightweight coated paper or a lightly coated paper.

3. The image forming method according to claim 1, wherein the aggregating agent is at least one selected from the group consisting of a polyvalent metal salt, an acidic substance and a cationic polymer.

4. The image forming method according to claim 3, wherein the aggregating agent is an acidic substance having a carboxyl group.

5. The image forming method according to claim 1, wherein the ink composition comprises solid components that are solid in the ink composition at 25° C., and liquid components that are liquid in the ink composition at 25° C. and have lower vapor pressure than water; a total content of the solid components in the ink composition is from 2.0% by mass to less than 20% by mass relative to a total mass of the ink composition; and a ratio (A/B) of a total content (A) of the liquid components in the ink composition and a total content (B) of the solid components in the ink composition is 0.70 to 1.75.

6. The image forming method according to claim 5, wherein a proportion of the resin particles in the total content (B) of the solid components in the ink composition is 40% by mass or greater.

7. The image forming method according to claim 5, wherein the total content (B) of the solid components in the ink composition is from 10% by mass to less than 20% by mass relative to a total mass of the ink composition.

8. The image forming method according to claim 1, wherein the resin particles are self-dispersing polymer particles.

9. The image forming method according to claim 1, further comprising heating the image recorded by applying the ink composition and applying the treatment liquid.

10. The image forming method according to claim 9, wherein the heating is at least one of drying of the image under the condition that a heat source and the recording medium are not in contact or fixing of the image under the condition that a heat source and the recording medium are in contact.

11. The image forming method according to claim 10, wherein a fixing temperature in the fixing is less than 100° C.

12. The image forming method according to claim 1, wherein a glass transition temperature of the resin particles is 80° C. or more.
